(19) United States
(12) Patent Application Publication
(10) Pub. No.: US 2026/0086712 A1
(43) Pub. Date: Mar. 26, 2026

(54) KEYBOARD DECODING USING TOUCH SENSING IMAGES

(71) Applicant: Google LLC, Mountain View, CA (US)

(72) Inventors: Piyawat Lertvittayakumjorn, Mountain View, CA (US); Shanqing Cai, Cambridge, MA (US); Peng Dou, Sunnyvale, CA (US); Sze Chit Ho, San Jose, CA (US); Shumin Zhai, Los Altos, CA (US)

(21) Appl. No.: 19/339,103

(22) Filed: Sep. 24, 2025

Related U.S. Application Data
(60) Provisional application No. 63/699,612, filed on Sep. 26, 2024.

(51) Int. Cl. G06F 3/04886; G06F 40/40; G06T 11/20

(52) U.S. Cl. CPC G06F 3/04886; G06F 40/40; G06T 11/26

(57) ABSTRACT

A computing device may detect user input on a presence-sensitive screen. In response to detecting the input, the method obtains indications representing the input and generates a touch sensing image from these indications. Information extracted from the touch sensing image is then input into an artificial intelligence (AI) model. The computing device applies the AI model to the information extracted from the touch sensing image to generate a distribution of candidate keys and their corresponding scores based on the touch sensing image. From this distribution, the method selects an alphanumeric key, which is subsequently outputted to the device's user interface in response to the selection.

### CLAIM OF PRIORITY

This application claims the benefit of U.S. Provisional Patent Application No. 63/699,612, filed 26 Sep. 2024, the entire contents of which is incorporated herein by reference.

### BACKGROUND

A virtual keyboard is an on-screen version of a physical keyboard, commonly used on touch-enabled devices such as smartphones and tablets. Users type by tapping on displayed keys, but may face challenges because virtual keyboards on smaller devices shrink key sizes, increasing the likelihood of input errors.

### SUMMARY

In general, the techniques of this disclosure are directed to techniques for enhancing keyboard decoding using touch sensing images. For example, an artificial intelligence (AI) model is trained to obtain input detected within a keyboard region of a touchscreen in the form of touch sensing images, and utilize the touch sensing images to predict the keyboard keys that a user intended to type using the touchscreen keyboard. In some examples, the AI model is trained to evaluate both the touch sensing images and a touch centroid associated with the input to predict the key that a user aimed to type on a touchscreen keyboard. According to some examples, the AI model utilizes a logistic regression classifier for processing the preprocessed touch sensing images and optionally a preprocessed centroid as input. In such an example, the output of the AI model represents the probabilities of N candidate keys, which will combine with signals from the language model to determine the final keyboard key. In some examples, the AI model outputs a normalized distribution of predicted keys providing a predictive weight for all of the candidate keys of a virtual keyboard having total values that sum to 1, in which case a candidate key with the highest predictive weight may be selected as the user's intended key. In examples where one or more touch sensing images and a touch centroid are utilized to make the prediction, extracted features from the one or more touch sensing images and the touch centroid may be combined into a single feature vector, from which the AI model generates the predictive output.

In one example, this disclosure describes a method that includes detecting, by one or more processors of a computing device, user input at a presence-sensitive screen. According to certain examples, the method includes, responsive to a detection of the user input at the presence-sensitive screen, obtaining, by the one or more processors, indications representative of the user input. In at least one example, the method includes generating, by the one or more processors, a touch sensing image from the indications representative of the user input detected at the presence-sensitive screen. According to such examples, the method includes inputting, by the one or more processors, information extracted from the touch sensing image into an artificial intelligence model. In one example, the method includes applying, by the one or more processors, the artificial intelligence model to the information extracted from the touch sensing image to generate a distribution of candidate keys and candidate key scores for the candidate keys based on the touch sensing image. According to certain examples, the method includes selecting, by the one or more processors, an alphanumeric key from the distribution of candidate keys and candidate key scores. In at least one example, the method includes, responsive to a selection of the alphanumeric key, outputting, by the one or more processors, the alphanumeric key selected to a user interface of the computing device.

In another example, this disclosure describes a computing device that includes a presence-sensitive screen. In such an example, the presence-sensitive screen of the computing device is configured to detect user input, for example, in the form of a user tap or a user touch within a keyboard region of a presence-sensitive display screen. According to certain examples, the computing device includes one or more processors configured to, responsive to a detection of the user input at the presence-sensitive screen, obtain indications representative of the user input. In at least one example, the one or more processors are configured to generate a touch sensing image from the indications representative of the user input detected at the presence-sensitive screen. According to such examples, the one or more processors are configured to input information extracted from the touch sensing image into an artificial intelligence model. In another example, the processors apply the artificial intelligence model to the information extracted from the touch sensing image to generate a probability distribution of the candidate keys based on the touch sensing image. In at least one example, the processors are configured to select an alphanumeric key from the distribution of candidate key scores. According to certain examples, the processors are configured to, responsive to a selection of the alphanumeric key, output the alphanumeric key selected to a user interface of the computing device. In some examples, the one or more processors may output a SPACE or a PERIOD.

In another example, this disclosure describes a non-transitory computer-readable storage medium encoded with instructions that, when executed by one or more processors, cause the one or more processors to detect user input at a presence-sensitive screen. According to certain examples, the instructions configure the processors to, responsive to a detection of the user input at the presence-sensitive screen, obtain indications representative of the user input. In at least one example, the instructions configure the processors to generate a touch sensing image from the indications representative of the user input detected at the presence-sensitive screen. According to such examples, the instructions configure the processors to input information extracted from the touch sensing image into an artificial intelligence model. In one example, the instructions configure the processors to apply the artificial intelligence model to the information extracted from the touch sensing image to generate a distribution of candidate keys and candidate key scores for the candidate keys based on the touch sensing image. According to certain examples, the instructions configure the processors to select an alphanumeric key from the distribution of candidate keys and candidate key scores. In at least one example, the instructions configure the processors to, responsive to a selection of the alphanumeric key, output the alphanumeric key selected to a user interface of the computing device.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating a keyboard decoding framework, in accordance with one or more aspects of the present disclosure.

FIG. 2 is a block diagram illustrating further details of an example computing device, in accordance with one or more aspects of the present disclosure.

FIGS. 3A, 3B, and 3C are diagrams illustrating example sequences of touch sensing images used by the computing device to perform disambiguation of user input in accordance with various aspects of the techniques described in this disclosure.

FIG. 4A depicts an example of the touch sensing image and a derived touch centroid appearing on the key “x” of virtual keyboard, in accordance with aspects of this disclosure.

FIG. 4B depicts the distribution of touch centroids in the dataset from Study 1, pooled across all 24 participants, in accordance with aspects of this disclosure.

FIG. 5 depicts a conceptual diagram for the process of computing a heatmap overlap feature for the boxed key generated from a heatmap overlap vector, in accordance with aspects of this disclosure.

FIG. 6 depicts a (CHO) logistic regression type AI model which takes as input, both a raw touch centroid and a raw touch sensing image and provides predicted probabilities of the candidate keys (p^{SM}) using a final distribution, in accordance with aspects of this disclosure.

FIG. 7 depicts character distributions of a common prompt pool, a final prompt pool for greedy selection, 90 selected prompts used for data collection, and the processed dataset used for training and evaluation, in accordance with aspects of this disclosure.

FIG. 8 is a flowchart illustrating example operations performed by an example computing device that is configured in accordance with one or more aspects of the present disclosure.

### DETAILED DESCRIPTION

In general, the techniques of this disclosure are directed to techniques for enhancing keyboard decoding of mobile touchscreens with touch sensing images. For example, an artificial intelligence (AI) model is trained to obtain input detected within a keyboard region of a touchscreen in the form of touch sensing images, and utilize the touch sensing images to predict the keyboard keys that a user aimed to type on a touchscreen keyboard with greater accuracy than prior known techniques. In some examples, the AI model is trained to evaluate both the touch sensing images and a touch centroid associated with the input to predict the key that a user aimed to type on a touchscreen keyboard. According to some examples, the AI model utilizes a logistic regression classifier for processing the preprocessed touch sensing images and optionally a preprocessed centroid as input. In such an example, the output of the AI model represents the probability of N candidate keys, which will combine with signals from the language model to determine the final keyboard key. In some examples, the AI model outputs a normalized distribution of predicted keys providing a predictive weight for all of the keys of a virtual keyboard having total values that sum to 1, in which case a candidate key with the highest predictive weight may be selected as the user's intended key. In examples where both touch sensing images and a touch centroid are utilized to make the prediction, extracted features of both the touch sensing images and a touch centroid may be combined into a single feature vector, from which the AI model generates the predictive output.

Prior techniques utilized only the touch centroid of a user tap as input for keyboard decoding. Conversely, the keyboard decoding framework utilizes the touch sensing image of the user tap and may optionally utilize the touch centroid as an additional input to further increase accuracy. Previous methods predict the user's intended key in most circumstances by leveraging the touch centroid data specific to that user which may improve overtime as the user's typing patterns are better learned. Nonetheless, such prior techniques suffer for certain use cases, such as small virtual keyboards, all thumbs typing, users with relatively larger fingers in comparison to the keyboard, user input interactions at or near borders of the keyboard keys, and so forth. In contrast, the described approach leverages sensing images and optionally the touch centroids from any users and was demonstrated experimentally to generalizable well to unseen users.

The keyboard decoding framework may implement a machine learning (ML) model and/or an artificial intelligence (AI) model that accepts as input, a touch sensing image to predict the key that a user aims to type on a virtual touchscreen keyboard, with the option of also using the touch centroid to further increase accuracy. The AI model may utilize a logistic regression classifier to process the touch sensing image as input and to combine the touch sensing image with the touch centroid when needed. Output from the AI model represents the probability of N candidate keys, from which, subsequent downstream AI model(s) or subsequent post-processing may predict the final key.

To train and evaluate the AI model, touch sensing image data and touch centroid data was collected from participants who completed copy-typing tasks. Taps were aligned with the text requested for typing, utilizing the aligned (tap—intended key) pairs for model training.

The keyboard decoding framework improves upon prior known techniques through the utilization of capacitive images (i.e., the touch sensing image) for keyboard decoding. Experimental results indicate that incorporating touch sensing images results in a 21.4% relative reduction in character error rate (CER) compared to the centroid-only baseline CER of 4.22%. With further downstream processing assistance from language models and additional techniques, the relative CER reduction achieves 29.7% from the centroid-only baseline CER of 2.87%. A lower CER indicates fewer misinterpretations of user taps, leading to reduced typing errors and improved speed and user experience.

According to aspects of the disclosure, the touch sensing image may be transformed into a heatmap overlap vector to further increase the generalizability of the trained AI model and specifically to improve spatial processing of the AI model, thus enabling higher accuracy of predicted keys when encountering previously unseen text which forms no part of the training dataset.

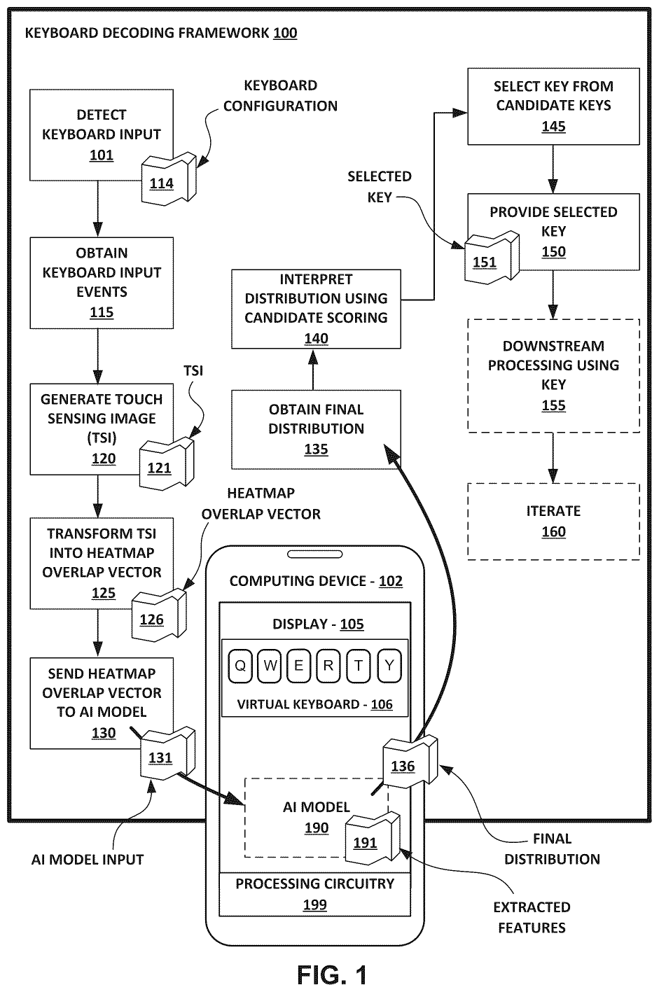

FIG. 1 is a conceptual diagram illustrating keyboard decoding framework 100, in accordance with one or more aspects of the present disclosure. More particularly, as shown in FIG. 1, keyboard decoding framework 100 includes various interactions by computing device 102 (e.g., a mobile computing device) with artificial intelligence model 190 and various user interactions. Display 105 of computing device 102 provides a touch sensitive interactive interface which may display, for example, virtual keyboard 106.

Virtual keyboards 106 are on-screen representations of traditional keyboards, primarily used on touchscreen devices such as smartphones, tablets, and computers. Virtual keyboards 106 enable users to input text by tapping on keys output via display 105. The design of virtual keyboards 106 can vary based on device size and user preferences and may interact with other components of computing device 102 including, for example, AI model 190 to provide additional features such as predictive text, autocorrect, and gesture typing to enhance user experience. However, challenges such as virtual keyboards on smaller electronic devices having small key sizes can lead to increased input errors due to the small size of touch targets.

The small size of touch targets creates a problem in which users encounter difficulty when tapping small targets on touchscreen devices, leading to unintended inputs. This issue arises because human fingers tend to be larger than the keys on virtual keyboards 106, resulting in touch overlap between adjacent keys. As a result, user inputs may mistakenly activate the wrong key (e.g., unintended key), which can reduce typing accuracy and speed. This problem is particularly prominent on smaller devices where key sizes are limited. Various solutions, such as larger buttons, predictive text, and gesture typing, aim to mitigate this problem and improve the overall typing experience. Use of keyboard decoding framework 100 may improve overall typing accuracy, even when touch overlap between adjacent keys occurs, through the utilization of touch sensing images when paired with AI model 190 enabled to interpret the touch sensing image input to provide higher accuracy key predictions. The higher accuracy key predictions by AI model 190 may result in greater user satisfaction and generally improved user experiences when interacting with mobile devices, especially those having a small form factor which necessitates a smaller virtual keyboard 106 output by display 105.

Computing device 102 may implement an artificial intelligence model 190 to determine extracted features 191 from AI model input 131 and to generate final distribution 136 providing candidate keys (e.g., multiple possible keyboard keys) for AI model input 131 as well as scoring information for each of the multiple candidate keys. Further downstream processing or downstream AI models, such as a downstream large language model, may consume as input, final distribution 136 provided by AI model 190 as output to generate additional predictive output, such as the final predicted key, a predicted word, a corrected word, and/or a predicted string of multiple words. In other examples, AI model 190 may simply output a single key as the predicted key based on candidate key scoring provided by final distribution 136. AI model 190 and downstream AI models may include, for example, machine learning (ML) models, chatbots, generative pre-trained transformer (GPT) models such as Gemini, large language models (LLMs), natural language processing (NLP) models, computer vision models for object recognition and classification, graphics based search models, and image generation models for outputting computer generated visual information responsive to written prompts.

When computing device 102 interacts with AI model 190, computing device 102 may provide additional context or input to AI model 190 including, for example, a priori information such as keyboard configuration 114 information or keyboard calibration information. For instance, keyboard configuration 114 may describe the size, dimensions, spacing, arrangement, language, orientation, and/or positioning of virtual keyboard 106 output via display 105. Computing device 102 may additionally activate AI model 190 by first detecting keyboard input (101) at virtual keyboard 106. In other examples, computing device 102 may send keyboard configuration 114 information for virtual keyboard 106 to artificial intelligence model 190 executing at a third-party cloud platform communicably interfaced with computing device 102 over a public Internet. In such a way, computing device 102 may utilize a locally installed AI model 190, a remote AI model 190, or both, as needed.

For instance, with reference to FIG. 1, keyboard decoding framework 100, using processing circuitry 199 of computing device 102 may detect keyboard input 101, such as input interactions with virtual keyboard 106 output via display 105 of computing device 102. Processing circuitry 199 of computing device 102 may optionally obtain keyboard configuration 114 information about virtual keyboard 106.

Keyboard decoding framework 100 may obtain keyboard input events 115 including, for example, location, pressure, intensity, duration, and so forth for any given input detected relative to virtual keyboard 106. Processing circuitry 199 of computing device 102 may generate touch sensing image 120 using the keyboard input events obtained (115) resulting in touch sensing image (TSI) 121. Processing circuitry 199 of computing device 102 may transform TSI 121 into a heatmap overlap vector (125) resulting in heatmap overlap vector 126.

According to such an example, at block 130, processing circuitry 199 of computing device 102 may send heatmap overlap vector 126 to AI model 190 as AI model input 131. Processing circuitry 199 of computing device 102, using AI model 190, generates extracted features 191 from AI model input 131 to generate final distribution 136 representing multiple possible candidate keys for the corresponding keyboard input detected at block 101. Such final distribution 136 may include, for instance, all possible keyboard keys as candidate keys, each with a corresponding candidate key score provided as a ranking or as a distribution from least likely to most likely. For instance, final distribution 136 from AI model 190 may represent the probabilities associated with each candidate key based on the predictions generated by AI model 190. For instance, final distribution 136 output from AI model 190 may include a list of all possible candidate keys along with their corresponding weights or probabilities. Each candidate key would have an associated weight indicating the likelihood that it is the intended key based on AI model input 131 provided to AI model 190. Final distribution 136 may allow AI model 190 or other downstream processing tasks to rank the candidate keys provided and to choose which one of the multiple candidate keys are to be selected as the predicted output, which may correspond to the candidate key with the highest probability or a different candidate key, even when not the highest probability, based on other factors and weightings applied by downstream processing tasks.

As depicted, at block 135, processing circuitry 199 of computing device 102 may obtain final distribution 136 from AI model 190 and at block 140, processing circuitry 199 of computing device 102 may interpret the distribution using the candidate scoring provided with final distribution 136. At block 145, processing circuitry 199 of computing device 102 selects a key from the multiple candidate keys to provide the selected key 151 as indicated by block 150.

At block 155, processing circuitry 199 of computing device 102 may apply optional downstream processing using selected key 151 or optionally utilizing final distribution 136 having the multiple candidate keys and candidate key scoring information. For instance, an LLM may generate predicted text, generate predicted next words, generate predicted word spelling corrections and/or predicted word grammatical corrections, or generate predicted sequences of words, emojis and/or emoticons. Downstream processing using key (155) may be simplistic, such as accepting selected key 151 and appending selected key 151 to an input string generated based on user input (e.g., displaying selected key 151 as the next letter typed by the user) or may be more complex, such as an application initiating an action based on selected key 151, such as a game action (e.g., move, jump, shoot), an navigation action (e.g., select and navigate to a sub-menu, web-page, link, etc.), and/or a downstream AI model action based on selected key 151 or based on final distribution 136 (e.g., predicting a word typed, a next word to be typed, an emojis and/or emoticons to be typed, etc.).

At block 160, processing circuitry 199 of computing device 102 may iterate by returning to the beginning of the processing sequence at block 101 and detecting new keyboard input, such as the next letter typed onto virtual keyboard 106 by a user.

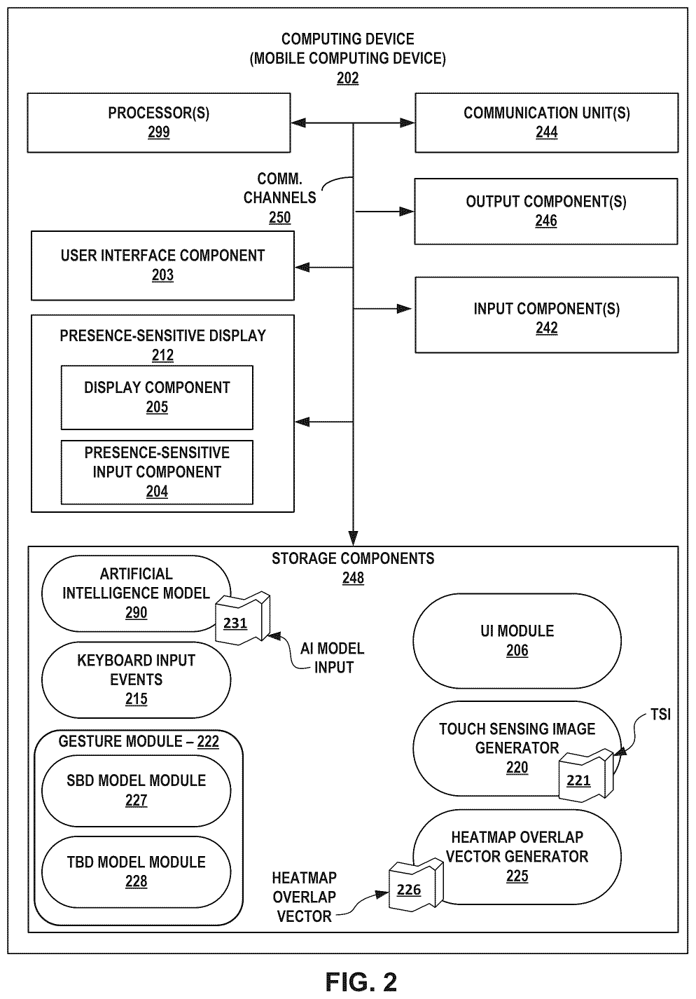

FIG. 2 is a block diagram illustrating further details of an example computing device, in accordance with one or more aspects of the present disclosure. Computing device 202 of FIG. 2 is described below as an example of computing device 102 as illustrated in FIG. 1.

Computing device 202 of FIG. 2 may be an example of a mobile phone, a tablet computer, a laptop computer, a desktop computer, a server, a mainframe, a set-top box, a television, a wearable device (including watches, glasses, rings, etc.), a home automation device or system, a gaming system, a media player, an e-book reader, a mobile television platform, an automobile navigation or infotainment system, or any other type of mobile, non-mobile, wearable, and non-wearable computing device configured to communicate with a network, such as a local network or a public Internet.

FIG. 2 illustrates only one particular example of computing device 202, and many other examples of computing device 202 may be used in other instances and may include a subset of the components included in example computing device 202 or may include additional components not shown in FIG. 2.

As shown in the example of FIG. 2, computing device 202 includes user interface component (UIC) 203, presence-sensitive display (PSD) 212 having display component 205 and presence-sensitive input component 204, one or more processors 299, one or more input components 242, one or more communication units 244, one or more output components 246, gesture module 222 having shape-based disambiguation (“SBD”) model module 227 and time-based disambiguation (“TBD”) model module 228, and one or more storage components 248. Storage components 248 of computing device 202 also include user interface (UI) module 206, artificial intelligence (AI) model 290 enabled to accept AI model input 231, keyboard input events 215, touch sensing image generator 220 enabled to generate touch sensing image 221, and heatmap overlap vector generator 225 enabled to provide heatmap overlap vector 226, for instance, for use as AI model input 231 into AI model 290.

One or more processors 299 are one example of processing circuitry 199 of FIG. 1. UI module 206, as shown in the example of FIG. 2, may be operable by computing device 202 to perform one or more functions, such as receive input and send indications of such input to other components associated with computing device 202, such as AI model 290 and/or available application modules including touch sensing image generator 220 and heatmap overlap vector generator 225. UI module 206 may also receive data from components associated with computing device 202 such as AI model 290 and/or available application modules including touch sensing image generator 220 and heatmap overlap vector generator 225. Using the data received, UI module 206 may cause other components associated with computing device 202, such as UI component 203, to provide output based on the data. For instance, UI module 206 may receive data from AI model 290, touch sensing image generator 220, heatmap overlap vector generator 225 to display a graphical user interface (GUI). Such output may include a final distribution of candidate keys and candidate key scoring (e.g., see 136 of FIG. 1), predicted keyboard keys, predictive text, etc.

Display 205 is an example of display 105 of FIG. 1. AI model 290 is an example of AI model 190 of FIG. 1. AI model input 231 is an example of AI model input 131 of FIG. 1. Touch sensing image (TSI) 221 is an example of TSI 121 of FIG. 1. Storage components 248 including touch sensing image generator 220 and heatmap overlap vector generator 225 may provide touch sensing image 121 and heatmap overlap vector 126 of FIG. 1, respectively.

Touch sensing image 221 is a high-resolution representation of a touch event on a touchscreen type display 205. When a user touches display 205, capacitive sensors record not just a touch centroid but also an entire contact area of the user's finger or input device (e.g., stylus, etc.), often forming a circular or elliptical shape. This touch sensing image 221 captures pressure distribution, size, and shape, providing significantly more information than the touch centroid alone. In virtual keyboards (e.g., see 105 of FIG. 1), touch sensing image 221 helps AI model 29 interpret the touch and distinguish between adjacent keys, leading to more accurate key prediction. Touch sensing image 221 may be derived from keyboard input events (e.g., see block 115 of FIG. 2), for instance, by processors 299 of computing device 202 using touch sensing image generator 220.

Heatmap overlap vector 226 may be derived from touch sensing image 221, for instance, by processors 299 of computing device 202 using heatmap overlap vector generator 225. Heatmap overlap vector 226 visualizes how much of a keyboard input event overlaps with each key of a virtual keyboard (see 105 of FIG. 1), representing the likelihood of each key being the intended target based on the touch shape and position of a user interaction. Heatmap overlap vector 226 may be created by mapping touch sensing image 221 onto the keyboard layout and calculating the overlap of the touch area with each key. These overlaps are converted into a numerical vector which may then be provided to AI model 290. In some examples, AI model 290 may generate one or both of touch sensing image 221 and/or heatmap overlap vector 226 from keyboard input events provided to AI model 290 as input. In other examples, computational burden on AI model 290 is reduced by providing as input to AI model 290, a preprocessed heatmap overlap vector 226 from which a final distribution (see 136 of FIG. 1) of candidate keys and candidate key scores may be generated.

Use of touch sensing image 221 and/or a derived heatmap overlap vector 226 by AI model 290 leverage spatial and touch pattern data to increase prediction accuracy of virtual keyboard input, reducing errors from issues such overly small key sizes on small devices, increasing the likelihood of input errors.

PSD 212 of computing device 202 includes display component 205 and presence-sensitive input component 204. Display component 205 may be a screen at which information is displayed by PSD 212 and presence-sensitive input component 204 may detect an object at and/or near display component 205. As one example range, presence-sensitive input component 204 may detect an object, such as a finger or stylus that is within two inches or less of display component 205. Presence-sensitive input component 204 may determine a location (e.g., an [x, y] coordinate) of display component 205 at which the object was detected. In another example range, presence-sensitive input component 204 may detect an object six inches or less from display component 205 and other ranges are also possible. Presence-sensitive input component 204 may determine the location of display component 205 selected by a user's finger using capacitive, inductive, and/or optical recognition techniques. In some examples, presence-sensitive input component 204 also provides output to a user using tactile, audio, or video stimuli as described with respect to display component 205. In the example of FIG. 2, PSD 212 may present a user interface (such as a graphical user interface presented using UI component 203) for receiving text input by obtaining keyboard input events 115 and outputting a selected key 151 inferred from the keyboard input events as shown in FIG. 1).

While illustrated as an internal component of computing device 202, PSD 212 may also represent an external component that shares a data path with computing device 202 for transmitting and/or receiving input and output. For instance, in one example, PSD 212 represents a built-in component of computing device 202 located within and physically connected to the external packaging of computing device 202 (e.g., a screen on a mobile phone). In another example, PSD 212 represents an external component of computing device 202 located outside and physically separated from the packaging or housing of computing device 202 (e.g., a monitor, a projector, etc. that shares a wired and/or wireless data path with computing device 202).

PSD 212 of computing device 202 may receive tactile input from a user of computing device 202. PSD 212 may receive indications of the tactile input by detecting one or more tap or non-tap gestures from a user of computing device 202 (e.g., the user touching or pointing to one or more locations of PSD 212 with a finger or a stylus pen). PSD 212 may present output to a user. PSD 212 may present the output as a graphical user interface (e.g., a graphical user interface using UI component 203), which may be associated with functionality provided by various functionality of computing device 202. For example, PSD 212 may present various user interfaces of components of a computing platform, operating system, applications, or services executing at or accessible by computing device 202 (e.g., an electronic message application, a navigation application, an Internet browser application, a mobile operating system, etc.). A user may interact with a respective user interface to cause computing device 202 to perform operations relating to one or more of the various functions. The user of computing device 202 may view output presented as feedback associated with obtained keyboard input events (see 115 of FIG. 1) and provide input to PSD 212 to compose text using the obtained keyboard input events.

PSD 212 of computing device 202 may detect two-dimensional and/or three-dimensional gestures as input from a user of computing device 202. For instance, a sensor of PSD 212 may detect a user's movement (e.g., moving a hand, an arm, a pen, a stylus, etc.) within a threshold distance of the sensor of PSD 212. PSD 212 may determine a two or three dimensional vector representation of the movement and correlate the vector representation to a gesture input (e.g., a hand-wave, a pinch, a clap, a pen stroke, etc.) that has multiple dimensions. In other words, PSD 212 can detect a multi-dimensional gesture without requiring the user to gesture at or near a screen or surface at which PSD 212 outputs information for display. Instead, PSD 212 can detect a multi-dimensional gesture performed at or near a sensor which may or may not be located near the screen or surface at which PSD 212 outputs information for display.

Gesture module 222 may perform operations for disambiguating user input. That is, gesture module 222 may perform various aspects of the techniques described in this disclosure to disambiguate user input, determining a classification of the user input based on a sequence of heatmaps as described above.

SBD model module 227 of gesture module 222 may represent a model configured to disambiguate user input based on a shape of the sequence of multi-dimensional heatmaps stored to storage components 248. In some examples, each of the heatmaps of the sequence of multi-dimensional heatmaps represents capacitance values for a region of presence-sensitive display 212 for an 8 ms duration of time. SBD model module 227 may, as one example, include a neural network or other machine learning model trained to perform the disambiguation techniques described in this disclosure. In some examples, AI model 290 implements neural network or other machine learning model and/or operates in conjunction with SBD model module 227 to perform character disambiguation techniques including character decoding for input obtained from a virtual keyboard.

TBD model module 228 may represent a model configured to disambiguate user input based on time-based, or in other words, duration-based thresholds. TBD model module 228 may perform time-based thresholding to disambiguate user input. TBD model module 228 may represent, as one example, a neural network of AI model 290 or other machine learning model trained to perform the time-based disambiguation aspects of the techniques described in this disclosure. Although shown as separate models, SBD model module 227 and TBD model module 228 may be implemented as a single model capable of performing both the shape-based and time-based disambiguation aspects of the techniques described in this disclosure.

AI model 290, SBD model module 227, and TBD model module 228, when applying neural networks or other machine learning algorithms, may be trained based on a set of example indications representative of user input (such as the above noted heatmaps and centroids, respectively). That is, SBD model module 227 may be trained using different sequences of touch sensing images 221 representative of user input, each of the sequences of touch sensing images 221 associated with the different classification events (e.g., long press event, tap event, scrolling event, etc.). SBD model module 227 may be trained until configured to classify unknown events correctly with some confidence level (or percentage). Similarly, TBD model module 228 may be trained using different touch centroid sequences representative of user input, each of the touch centroid sequences associated with different classification events (e.g., long press event, tap event, scrolling event, etc.).

Storage components 248 may store the plurality of multi-dimensional touch sensing images 221. Although described as storing the sequence of multi-dimensional touch sensing images 221, storage components 248 may store other data related to gesture disambiguation, including the handedness, finger identification or other data. Threshold data stores may be used to store one or more temporal thresholds, distance or spatial based thresholds, probability thresholds, or other values of comparison that gesture module 222 uses to infer classification events from user input. The thresholds stored by such threshold data stores may be variable thresholds (e.g., based on a function or lookup table) or fixed values.

Although described with respect to handedness (e.g., right handed, left handed) and finger identification (e.g., index finger, thumb, or other finger), the techniques may determine other data based on the touch sensing images 221, such as the weighted area of the heatmap, the perimeter of the heatmap (after an edge-finding operation), a histogram of heatmap row/column values, the peak value of the heatmap, the location of the peak value relative to the edges, centroid-relative calculations of these feature, or derivatives of these features. The threshold data stores may store this other data as well.

Presence-sensitive input component 204 may initially receive indications of capacitance, which presence-sensitive input component 204 forms into a plurality of capacitive touch sensing images 221 representative of the capacitance in the region of presence-sensitive display 212 reflective of the user input entered at the region of the presence-sensitive display 212 over the duration of time. In some instances, communication channels 250 (which may also be referred to as a “bus 250”) may have limited throughput (or, in other words, bandwidth). In these instances, presence-sensitive input component 204 may reduce a number of the indications to obtain a reduced set of indications. For example, presence-sensitive input component 204 may determine the touch centroid at which the primary contact with presence-sensitive display 212 occurred, and reduce the indications to those centered around the centroid (such as a 7×7 grid centered around the centroid). Presence-sensitive input component 204 may determine, based on the reduced set of indications, the plurality of multi-dimensional touch sensing images 221, storing the plurality of multi-dimensional heatmaps to storage components 248 via bus 250.

AI model 290 and SBD model module 227 may access touch sensing images 221 stored to storage components 248, applying one or more of the neural network to determine the changes, over the duration of time, in the shape of the sequence of multi-dimensional touch sensing images 221. SBD model module 227 may next apply the one or more neural networks, responsive to the changes in the shape of the plurality of multi-dimensional touch sensing images 221, to determine a classification of the user input.

AI model 290 and SBD model module 227 may also determine, based on changes to the shape of the multi-dimensional touch sensing images 221, a handedness of the user entering the user input, or which finger, of the user entering the input, was used to enter the user input. AI model 290 and SBD model module 227 may apply the one or more of the neural networks to determine the handedness or which finger, and apply the one or more neural networks to determine the classification of the user input based on the determination of the handedness or the determination of which finger.

Gesture module 222 may also invoke TBD model module 228 to determine the classification of the user input using time-based threshold (possible in addition to the centroids of the sequence of touch sensing images 221). As an example, TBD model module 228 may determine, based on a duration threshold, a tap event indicative of a user entering the user input performing at least one tap on the presence-sensitive screen. Gesture module 222 may then determine the classification from the combined results output by SBD model module 227 and the TBD model module 228.

Communication channels 250 may interconnect each of components 299, 204, 212, 202, 203, 204, 244, 246, 242, and 248 for inter-component communications (physically, communicatively, and/or operatively). In some examples, communication channels 250 may include a system bus, a network connection, an inter-process communication data structure, or any other method for communicating data.

One or more input components 242 of computing device 202 may receive input. Examples of input are tactile, audio, and video input. One or more input components 242 of computing device 202, in one example, includes a presence-sensitive display, touch-sensitive screen, mouse, keyboard, voice responsive system, video camera, microphone or any other type of device for detecting input from a human or machine.

One or more output components 246 of computing device 202 may generate output. Display component 205 is one example of an output component 246. Examples of output are tactile, audio, and video output. One or more output components 246 of computing device 202, in one example, includes a presence-sensitive display, sound card, video graphics adapter card, speaker, liquid crystal display (LCD), light-emitting diode (LED) display, miniLED, microLED, organic light-emitting diode (OLED) display, a light field display, haptic motors, linear actuating devices, or any other type of device for generating output to a human or machine.

One or more communication units 244 of computing device 202 may communicate with external devices via one or more wired and/or wireless networks by transmitting and/or receiving network signals on the one or more networks. Examples of one or more communication units 244 include a network interface card (e.g., an Ethernet card), an optical transceiver, a radio frequency transceiver, a GPS receiver, or any other type of device that can send and/or receive information. Other examples of one or more communication units 244 may include short wave radios, cellular data radios, wireless network radios, as well as universal serial bus (USB) controllers.

UIC 204 of computing device 202 may be hardware that functions as an input and/or output device for computing device 202. For example, UIC 204 may include a display component, which may be a screen at which information is displayed by UIC 204 and a presence-sensitive input component that may detect an object at and/or near the display component.

One or more processors 299 may implement functionality and/or execute instructions within computing device 202. For example, one or more processors 299 on computing device 202 may receive and execute instructions stored by storage components 248 that execute the functionality of keyboard decoding framework 100 of FIG. 1, including executing artificial intelligence model 290, touch sensing image generator 220 and heatmap overlap vector generator 225. The instructions executed by one or more processors 299 may cause computing device 202 to store information within storage components 248 during program execution. Examples of one or more processors 299 include application processors, display controllers, sensor hubs, and any other hardware configured to function as a processing unit. One or more processors 299 may execute instructions of UI module 206, artificial intelligence model 290, expanded functionality application 253, and reduced functionality application 255 to perform actions or functions. That is, UI module 206, artificial intelligence model 290, touch sensing image generator 220 and heatmap overlap vector generator 225 may be operable by one or more processors 299 to perform various actions or functions of computing device 202.

One or more storage components 248 within computing device 202 may store information for processing during operation of computing device 202. That is, computing device 202 may store data accessed by UI module 206, artificial intelligence model 290, touch sensing image generator 220, and heatmap overlap vector generator 225 during execution at computing device 202. In some examples, storage component 248 is a temporary memory, meaning that a primary purpose of storage component 248 is not long-term storage. Storage components 248 on computing device 202 may be configured for short-term storage of information as volatile memory and therefore not retain stored contents if powered off. Examples of volatile memories include random access memories (RAM), dynamic random-access memories (DRAM), static random access memories (SRAM), and other forms of volatile memories known in the art.

Storage components 248, in some examples, also include one or more computer-readable storage media. Storage components 248 may be configured to store larger amounts of information than volatile memory. Storage components 248 may further be configured for long-term storage of information as non-volatile memory space and retain information after power on/off cycles. Examples of non-volatile memories include magnetic hard disks, optical discs, floppy discs, flash memories, or forms of electrically programmable memories (EPROM) or electrically erasable and programmable (EEPROM) memories. Storage components 248 may store program instructions and/or information (e.g., data) associated with UI module 206, artificial intelligence model 290, touch sensing image generator 220 and heatmap overlap vector generator 225.

One or more processors 299 are configured to execute UI module 206, artificial intelligence model 290, touch sensing image generator 220 and heatmap overlap vector generator 225 to perform any combination of the techniques described in this disclosure. For example, one or more processors 299 are configured to execute artificial intelligence model 290 to receive AI model input 231 and generate final distribution 136 (see FIG. 1) as predictive output. One or more processors 299 are configured to execute touch sensing image generator 220 to receive keyboard input events as input and generate touch sensing image 221 as output. One or more processors 299 are configured to execute heatmap overlap vector generator 225 to receive touch sensing image 221 as input and generate heatmap overlap vector 226 as output. One or more processors 299 are configured to execute AI model 290 to receive heatmap overlap vector 226 as AI model input 231 and to generate final distribution 136 (see FIG. 1) as predictive output.

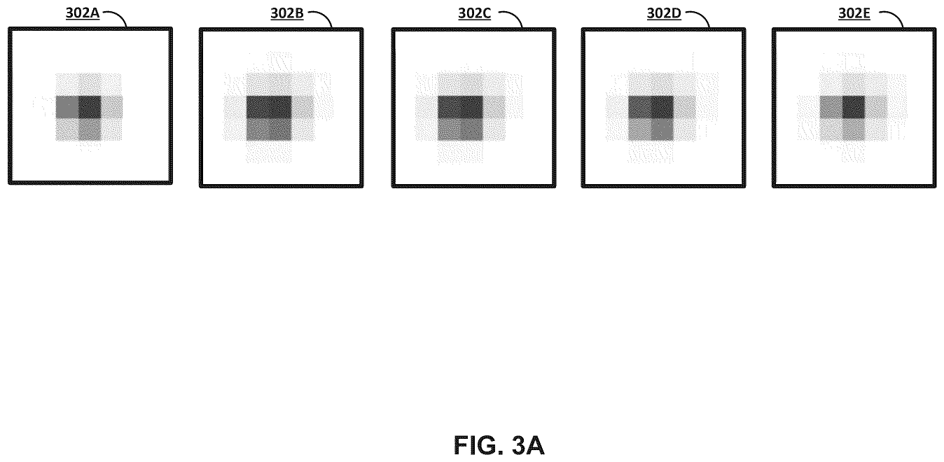

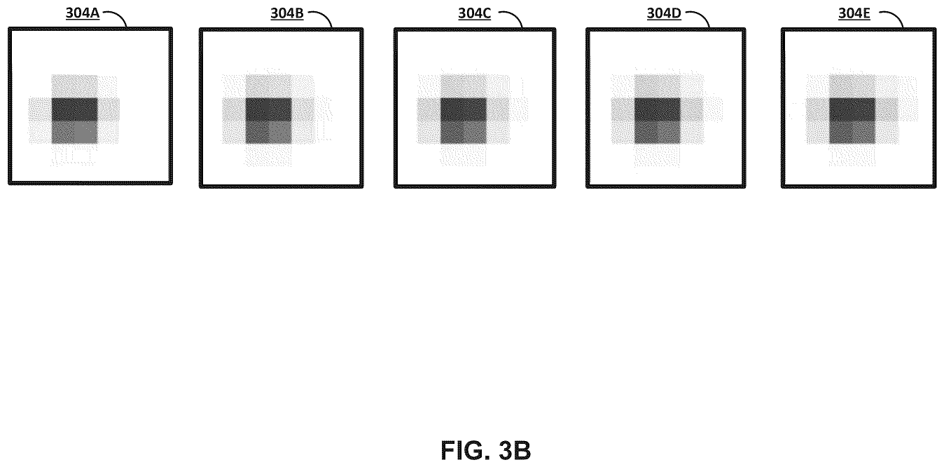

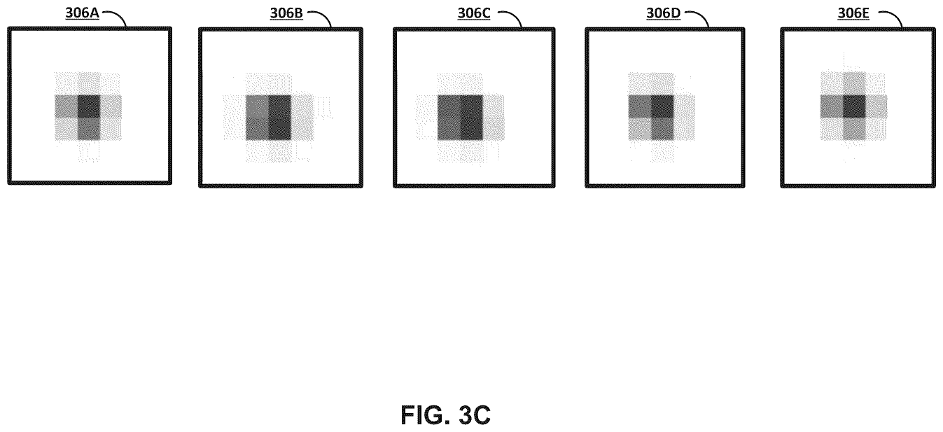

FIGS. 3A, 3B, and 3C are diagrams illustrating example sequences of touch sensing images used by the computing device to perform disambiguation of user input in accordance with various aspects of the techniques described in this disclosure. In the example of FIGS. 3A-3C, touch sensing images 302A-302E (“touch sensing images 302”), touch sensing images 304A-304E (“touch sensing images 304”), and touch sensing images 306A-306E (“touch sensing images 306”) include a 7×7 grid of capacitance values, with the more darkly colored boxes indicating either a higher or lower capacitance value relative to the lighter colored boxes. Touch sensing images 302 represent a sequence of touch sensing images collected over the duration of time, starting with touch sensing image 302A and through touch sensing image 302E in order time-wise. As such, touch sensing images 302 may represent changes in capacitance over the duration of time for the region. Touch sensing images 304 and 306 are similar to touch sensing image 302 in these respects as well.

Referring first to FIG. 3A, touch sensing images 302 were captured after the user tapped on presence-sensitive display 212. Gesture module 222 (shown in the example of FIG. 2) may invoke AI model 290, SBD model module 227 and/or TBD model module 228 to determine a classification of the user input based on the changes in shape of touch sensing images 302 over the duration of time. In some examples, each of the touch sensing images 302 are representative of 8 ms of time. The entire sequence of touch sensing images 302 may therefore represent 40 ms. Responsive to receiving touch sensing images 302, SBD model module 227 may determine that a tap occurs given the consistency of shape and intensity of the capacitance values. TBD model module 228 may determine a tap event, indicative of keyboard input events (see blocks 101 and 115 of FIG. 1), has occurred as a result of the short duration of the sequence of touch sensing images 302.

Referring next to FIG. 3B, touch sensing images 304 were captured after the user pressed on presence-sensitive display 212. Gesture module 222 may invoke AI model 290, SBD model module 227 and/or TBD model module 228 to determine a classification of the user input based on the changes in shape of touch sensing images 304 over the duration of time. Again, each of the touch sensing images 304 may be representative of 8 ms of time. The entire sequencer of touch sensing images 304 may therefore represent 40 ms. Responsive to receiving touch sensing images 304, SBD model module 227 may determine that a press event occurred given the increasing intensity over time. TBD model module 228 may determine a press event occurred as a result of the longer duration of the sequence of touch sensing images 304 (which only represent a subset of a larger number of the entire sequence of touch sensing images 304 for ease of illustration purposes).

Referring next to FIG. 3C, touch sensing images 306 were captured after the user scrolled on presence-sensitive display 212. Gesture module 222 may invoke SBD model module 227 and TBD model module 228 to determine a classification of the user input based on the changes in shape of touch sensing images 306 over the duration of time. Again, each of the touch sensing images 306 may be representative of 8 ms of time. The entire sequencer of touch sensing images 306 may therefore represent 40 ms. Responsive to receiving touch sensing images 306, SBD model module 227 may determine that a scroll event occurred given the highly variable intensity over time (and possibly the changing location of the centroid). TBD model module 228 may determine a press event occurred as a result of the longer duration of the sequence of touch sensing images 306 (and the changing location of the centroid).

In such a way, keyboard decoding framework 100 may disambiguate between key tap (e.g., key input) events versus other touch, press, swipe, and scroll, type gestures detected via presence-sensitive display 212.

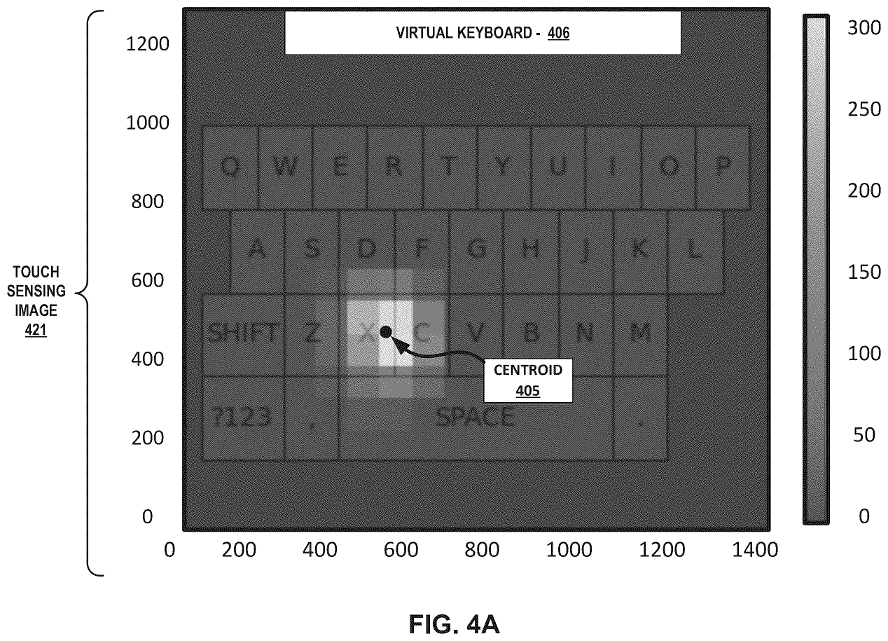

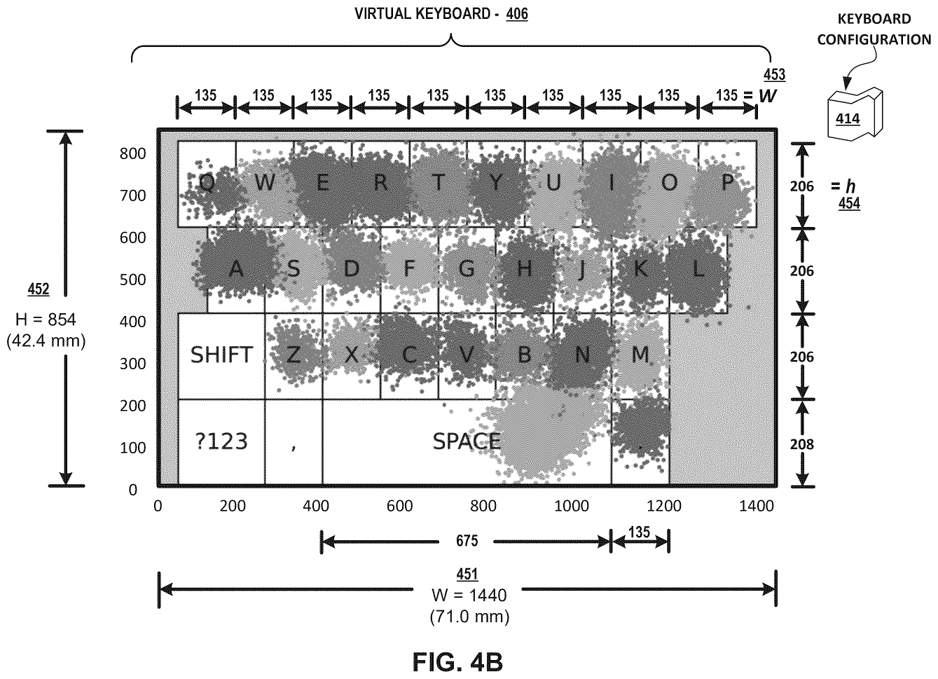

FIG. 4A depicts an example of the touch sensing image 421 and a derived touch centroid appearing on the key “x” of virtual keyboard 406, in accordance with aspects of this disclosure. FIG. 4A depicts virtual keyboard 406 with touch sensing image 421 and derived touch centroid 405. FIG. 4A is described with respect to computing device 102 of FIG. 1 and computing device 202 of FIG. 2. Touch sensing image 421 depicts a 16×18 colored grid overlaid atop the keyboard layout of virtual keyboard 406 and has a resolution scale of 1 pixel≈0.05 mm. Consider, for example, a user intending to type the letter “c” which is adjacent to the letter “x,” where derived touch centroid 405 appears fully within the regional space corresponding to the key “x.” Keyboard decoding framework 100 may generate touch sensing image 421 from one or more keyboard input events detected at virtual keyboard 406 and provide heatmap overlap vector 126 to artificial intelligence model 190 (see FIG. 1). In such an example, artificial intelligence model 190 generates final distribution 136 with candidate keys and candidate key scoring for accurately predicting the key “x” as the intended user key interaction.

Tap typing represents the most widely utilized method of text entry on mobile touchscreens. Tap typing is a method of text entry on mobile touchscreens in which a user may input text by tapping on virtual keyboard 406 displayed on the screen. Tap typing is particularly prevalent on smartphones, where the keyboards lack physical keys and boundaries. Smartphone keyboards are relatively small and lack physical boundaries between keys. Virtual keyboards 406 of smart watches, smart rings, and other small form factor computing devices may have even smaller virtual keyboard 406 displays or alternative presentation methods of virtual keyboards due to space constraints of the display for such devices. Nonetheless, computing device 102 (see FIG. 1) may interpret a user tap-represented as a touch point on computing device 102 differently than intended. This discrepancy leads to a specific category of typing errors known as spatial errors, such as the word “shock” being misinterpreted as “sj ock” (where “h” is misinterpreted as “j”) and “breathing” as “beeathing” (where “r” is misinterpreted as “e”) in the QWERTY keyboard layout.

Such errors diminish the effective typing speed of users and negatively impact the overall user experience. Spatial errors, often resulting from the small size of touch targets when using virtual keyboards on small electronic devices, are indicative that users are struggling to tap precisely on a touchscreen due to the relatively large size of human fingers, covered by soft malleable skin, resulting in hard-to-control contact areas on obscured target keys. An alternative explanation for this phenomenon is the perceived input point model, which posits that the center of the touch area, as reported by the device, typically locates at an offset below the user's intended position. This offset varies based on numerous factors, including the user's hand posture and typing mental model. According to the Finger-Fitts Law model (FFitts Law), the variability of touch centroid positions may originate from both the speed-accuracy tradeoff and the absolute precision uncertainty inherent in the finger tap action itself. The Finger-Fitts Law model (FFitts Law) describes the relationship between the speed and accuracy of finger movements when interacting with touchscreen interfaces. FFitts Law posits that the time taken to move to a target area (such as a key on a keyboard) is influenced by the size of the target and the distance to it. Essentially, the model suggests that smaller and more distant targets require more time to select accurately. FFitts Law is often used to analyze and optimize user interface design, aiming to enhance the efficiency of touch interactions by minimizing errors and improving overall usability.

Keyboard decoding framework 100 (see FIG. 1) may utilize information beyond the touch centroid 405 to increase key decoding accuracy. Such information may include properties of the user tap interaction, such as tap size and touch pressure, as well as contextual information regarding typing, including device motion, previously typed text, time elapsed between taps, and user identity. Keyboard decoding framework 100 may additionally utilize the capacitive image of the user tap depicted here as touch sensing image 421. Touch sensing image 421 provides two-dimensional spatial data captured by contact sensors of a capacitive touchscreen, such as that which is utilized by computing device 102 (see FIG. 1) to display virtual keyboard 406. As depicted here, touch centroid 405 is depicted concurrently with touch sensing image 421 atop a QWERTY style virtual keyboard 406 layout.

Touch centroid 405 may be derived from touch sensing image 421 or derived separately. In other examples, touch centroid 405 is derived independently from touch sensing image 421 utilizing user keyboard touch events. In some examples, keyboard decoding framework 100 utilizes touch sensing image 421 to predict a key and/or to generate a final distribution 136 of candidate keys and candidate key scoring from which a predicted key may be selected. In other examples, keyboard decoding framework 100 utilizes signals from both touch sensing image 421 and touch centroid 405, combining the signals from each to predict a key and/or to generate a final distribution 136 of candidate keys and candidate key scoring from which a predicted key may be selected. In some examples, touch sensing image 421 provides a summary of the touch pattern associated with a user keyboard touch event.

Keyboard decoding framework 100 was experimentally evaluated to determine whether tap-typing decoding and prediction accuracy could be increased through the use of such capacitance information represented by touch sensing image 421. Keyboard decoding framework 100 was demonstrated to outperform prediction accuracy by touch centroid 405 only models using touch sensing image 421 and increase prediction accuracy even further when touch sensing image 421 signals were combined with touch centroid 405 signals.

Keyboard decoding framework 100 leverages the information carried by touch sensing image 421 and optionally touch centroids 405 utilizing logistic regression models. Experiments trained AI models 190 (e.g., see FIG. 1) on data collected from users engaged in copy-typing texts on a smartphone, with touch sensing image 421 logged throughout the experiment. Various AI model 190 types may be utilized, including logistic regression, neural networks, gradient boosting, and random forest modeling. AI model 190 may be configured to utilize logistic regression due to its performance characteristics combined with providing one of the most accurate AI model types among those tested, while also being simple and lightweight, allowing for easy deployment. The simplicity and low computational burden of logistic regression may enable broader deployment as the logistic regression model type enables on-device processing (e.g., AI model 190 may be executed locally by processing circuitry 199 of computing device 102 and provide predictive results without sending AI model input 131 to a remote computing architecture for processing and generation of final distribution 136). On-device processing may additionally provide lower-latency (e.g., faster) results to users, thus further increasing user satisfaction when interacting with keyboard decoding framework 100.

Logistic regression models are statistical models used for predicting the probability of a binary outcome based on one or more predictor variables. Logistic regression models are particularly useful for classifying data into two categories, such as determining whether a specific key was tapped correctly or incorrectly during tap-typing. Logistic regression models may operate by applying a logistic function to a linear combination of input features, resulting in an output value between 0 and 1, which can be interpreted as the likelihood of a particular class. Moreover, use of logistic regression models experimentally demonstrated performance gains to different input feature sets. For the experiments, trained AI models 190 (see FIG. 1) underwent evaluation in two stages: First, utilizing offline datasets to test the generalizability of the trained AI models 190 to unseen users and phrases. And second, deploying the trained AI models 190 to measure practical effectiveness during real-time mobile text entry.

In such a way, keyboard decoding frameworks 100 was experimentally demonstrated to show that capacitive information represented by touch sensing images 421 include information beneficial for tap-typing decoding, which is not present within touch centroids 405 utilized by prior known techniques. For instance, incorporation of touch sensing images 421 resulted in a 21.4% relative reduction in character error rate (CER) compared to the centroid-only baseline CER of 4.22%. With the assistance of language models and additional techniques applied by downstream processing using the selected key 151 (e.g., see block 155 of FIG. 1), the relative CER reduction reached 29.7% from the centroid-only baseline CER of 2.87%.

Keyboard decoding frameworks 100 further enables generation of heatmap overlap vector 126 (see FIG. 1) which was experimentally demonstrated to enhance generalizability of the spatial processing capabilities of trained AI model 190, enabling AI model 190 to function effectively for the keyboard input events of unseen text which formed no part of the training dataset.

FIG. 4B depicts the distribution of touch centroids in the dataset from Study 1, pooled across all 24 participants, in accordance with aspects of this disclosure. FIG. 4B is described with respect to computing device 102 of FIG. 1 and computing device 202 of FIG. 2. This distribution is plotted on a QWERTY style virtual keyboard 406. Keyboard configuration 414 information (see also keyboard configuration 114 of FIG. 1) specifies keyboard width (W) 451, keyboard height (H) 452, key width (w) 453, and key height (h) 454 in pixels. Resolution scale is 1 pixel 0.05 mm.

Spatial errors associated with mobile keyboards may be affected due to different hand postures by users. For instance, touch centroids for each user and key of virtual keyboard 406 may be modeled as a bivariate Gaussian distribution, with the mean exhibiting a specific offset from the key center. Offsets vary across keys, postures, and users. Vertical and horizontal corrections to touch centroid based key prediction may therefore benefit from information about each user's hand posture as well as per-user personalization for typing habits. However, keyboard decoding framework 100 provides increased generalization by AI model 190 to unseen users and unseen typing characteristics without per-user personalization for user device, user posture, and user finger movement characteristics. Stated differently, keyboard decoding framework 100 provides increased generalization by AI model 190 for the distribution of touch centroids depicted by virtual keyboard 406 without requiring AI model training and customization on a per-user basis.

User context may be inferred for user posture by analyzing tap sizes and the time elapsed between taps to train a posture-specific spatial model to predict the intended key. Similarly, additional user context may be inferred from accelerometer-derived features to compensate for imprecise input during walking. Different key entry methods may also be interpreted, such as five-finger typing on a touchpad, extracting features from touch images such as duration, area, and pressure. However, keyboard decoding framework 100 leverages capacitance information from touch sense images to train a data-driven spatial AI model 190 (see FIG. 1) which provides greater accuracy and increased generalization across user postures, user typing characteristics, user devices, etc.

With reference to FIG. 1 at block 155, additional downstream processing using selected key 151 or final distribution 136 of candidate keys and candidate scoring may be applied to further improve text entry performance and prediction accuracy by integrating a character-level language model alongside or downstream from a spatial type AI model 190 trained to generate final distribution 136. For example, a downstream character-level language model may be configured to estimate the likelihood of the next character based on previously entered text. For example, if the user begins with the letter “s” the character-level language model may predict that the next character is more likely to be “h” than “j,” thus mitigating spatial errors, as demonstrated in the “shock”-4 “sj ock” example. In such an example, the character-level language model may downstream from the spatial type AI model 190 may accept as input, final distribution 136 of candidate keys and candidate scoring from AI model 190 and output a predicted key from final distribution 136 which does not correspond to the highest candidate key score in final distribution 136 based on a subsequent prediction of the most likely next character. According to aspects of the disclosure, language model scores are combined with spatial AI model 190 scores from final distribution 136 to better predict the user's intended key. Experimental results show that incorporating language model scores increases prediction accuracy of keyboard decoding framework 100 above use of the spatial AI model 190 alone or use of touch centroids alone.

A capacitive touchscreen refers to the display screen of a device (e.g., see display 105 of FIG. 1) capable of capturing an image of the user's finger contact area at specific moments. Projective Capacitive Touch (PCT) may be used in portable devices, such as smartphones and tablets. Projective Capacitive Touch is a touchscreen technology that uses electrodes separated by a dielectric layer to detect touch. When a conductive object, such as a finger, approaches the surface, it alters the capacitance, enabling precise detection of touch inputs on devices like smartphones and tablets. For instance, display 105 of computing device 102 may include multiple PCT sensors, with each PCT sensor having a pair of electrodes separated by a dielectric layer, which acts as a capacitor, holding a certain charge. The capacitance changes when a conductive object, such as a finger or stylus, approaches.

Display 105 of computing device 102 may include PCT sensors arranged in a grid under the screen's glass, generating two-dimensional touch sensing images 121, also called capacitive images. However, the resolution of touch sensing images 121 is lower than the display resolution for display 105. For example, computing device 102 used in the experiments provided a heatmap resolution of 39×18 compared to display 105 resolution of the computing device 102 which was 3120×1440. Keyboard decoding framework 100 may therefore utilize a touch controller to preprocess PCT sensor signals data, including applying noise removal and touch centroid derivation to the PCT sensor signals data to generate touch sensing images 121 (see e.g., block 120 of FIG. 1).

Additional preprocessing of PCT sensor signals data may include frequency variation and acoustic sensing, which may be applied to mass-produced low-resolution PCT capable display 105 devices to provide continuous quality and power refinement which in turn enables detectability of basic touchscreen inputs such as taps, swipes, and multi-finger gestures.

Human-Computer Interaction (HCl) research has shown that capacitive based touch sensing images 121 may provide valuable information to AI model 190 and downstream processing, including the ability to generate super-resolution images of touch areas and estimate user hand postures. These super-resolution images may be utilized to enable new user interaction modes on touchscreen capable devices 102.

For instance, AI model 190 and downstream processing using final distribution 136 may be trained to differentiate between one finger, two fingers, and palm touches based on capacitive images using Principal Component Analysis and decision tree techniques. Similarly, AI model 190 and downstream processing may be trained to use a Convolutional Neural Network (CNN) to classify touches as either finger or palm-based and predict finger orientation, touch pressure, and touch gestures such as tapping, pressing, or scrolling to enable new user interaction modes on touchscreen capable devices 102.

While prior centroid-based decoding techniques may assume point-like taps, keyboard decoding framework 100 is configured to utilize touch sensing images 121 which represent finger-screen contact areas that are not single point centroids. Ignoring touch shapes and pressures, such as those utilized by keyboard decoding framework 100 to improve prediction accuracy, may result in incomplete information for decoding ambiguous taps. According to aspects of the disclosure, keyboard decoding framework 100 preprocesses capacitive images to generate touch sensing images 121 and incorporates the touch sensing images 121 into logistic regression model training of AI model 190 for keyboard decoding.

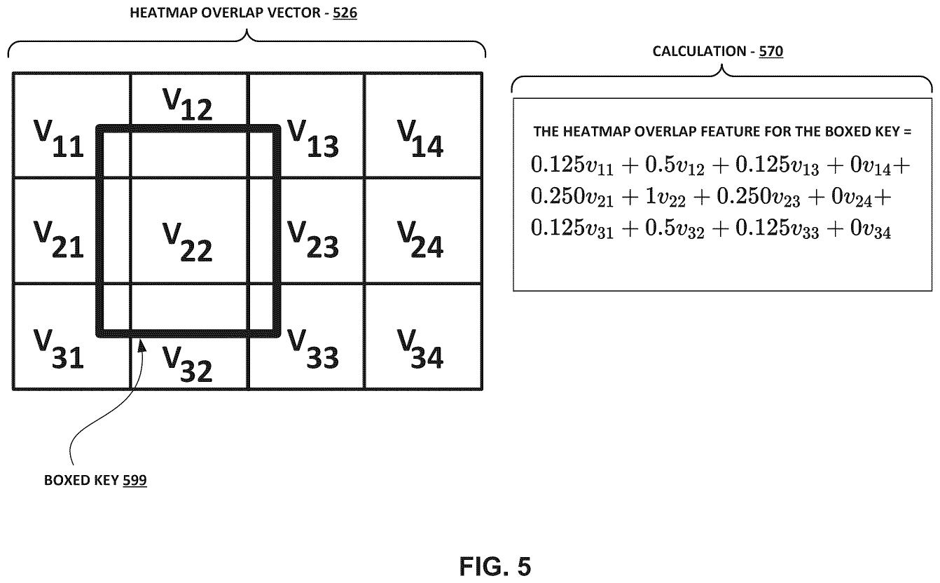

FIG. 5 depicts a conceptual diagram for the process of computing a heatmap overlap feature for boxed key 599 generated from heatmap overlap vector 526, in accordance with aspects of this disclosure. FIG. 5 is described with respect to computing device 102 of FIG. 1 and computing device 202 of FIG. 2. The key boundary is represented by boxed key 599, while heatmap overlap vector 526 is depicted by a grid on which boxed key 599 is placed.

The value viⱼ represents the intensity of the heatmap cell at row i and column j. For clarity in the illustration, heatmap overlap vector 526 is shown at a reduced size of (3×4) compared to its actual dimensions.

The devices used for the experiments were configured with virtual keyboard 406 layout as depicted by FIG. 4B, including the annotations of the keyboard dimensions, specifying keyboard width 451 (W=1,440 pixels), keyboard height 452 (H=854 pixels), the key width 453 (w=135 pixels), and key height 454 (h=206 pixels), which are referenced below.

Logistic regression-based spatial AI models 190 were trained for the experiment to evaluate use of touch sensing images 121 (see FIG. 1) by key decoding framework 100.

Variants of AI models 190 were trained to utilize either touch sensing images 121, touch centroids, or both, as input to predict the probabilities of candidate keys within final distribution 136. The experiments were conducted on 28 candidate keys (K=28), which include the 26 English letters, the space bar, and the period key. Differences in accuracy between variants of AI models 190 were attributed to the influence of touch sensing images 121 utilized by AI model 190 variants.

The experiments explored two types of features: touch sensing images 121 and touch centroids. For the touch centroid (C) at the position (x,y), it is represented by 28×2 numbers as [Δx₁,Δy₁,Δx₂,Δy₂, . . . , Δx₂₈,Δy₂₈] set forth according to Equation 1, set forth below, as follows:

$$Δ {x}_{k} = \frac{x - {x}_{k}}{w} and Δ {y}_{k} = \frac{y - {y}_{k}}{h} ,$$

where the terms Δxₖ and Δyₖ represent the normalized signed distances from the touch centroid (x,y) to the center of the kth key (xₖ, yₖ) along the x and y axes, respectively. As shown in FIG. 4B, the term w represents the most common key width in the keyboard layout (135 pixels), while the term h represents the most common key height (206 pixels). Min-max normalization is applied to all Δxₖ and Δyₖ, ensuring that feature values remain within the range [−1, 1].

For touch heatmaps, each frame is a single-channel image with dimensions of 39×18, generated by PCT sensors. Only the lower part of the image, covering the keyboard area (the last 16 rows), is used for efficient computation. Following the exploration of several alternatives, two heatmap feature representations were chosen for the empirical experiments: the flattened heatmap (H_{f}) and the heatmap overlap vector (Hₒ).

The flattened heatmap (Hf) is derived by converting the two-dimensional 16×18 heatmap intensity array into a vector of size 288, following a row-major order. In contrast, the heatmap overlap vector (Hₒ) represents the heatmap as a vector f of size 28, corresponding to the 28 candidate keys. Each value in the vector is the weighted sum of the intensities of heatmap cells overlapping the corresponding key area. Mathematically, this is expressed according to Equation 2, set forth below, as follows:

$${f}_{k} = {\sum }_{i = 1}^{16} {\sum }_{j = 1}^{18} \frac{O ( k , i , j )}{{A}_{k}} {v}_{ij} ,$$

where the term fₖ represents the value in the heatmap overlap vector for the kth candidate key, which has an area Ak in the keyboard layout. The value vᵢⱼ denotes the intensity of the heatmap cell located at row i and column j, while O(k,i,j) represents the overlapping area between the kth candidate key and the heatmap cell at row i and column j. An illustration of calculation 570 is shown in FIG. 5. Similar to the centroid, min-max normalization is applied to both the flattened heatmap and the heatmap overlap vector, ensuring that all feature values fall within the range [−1, 1].

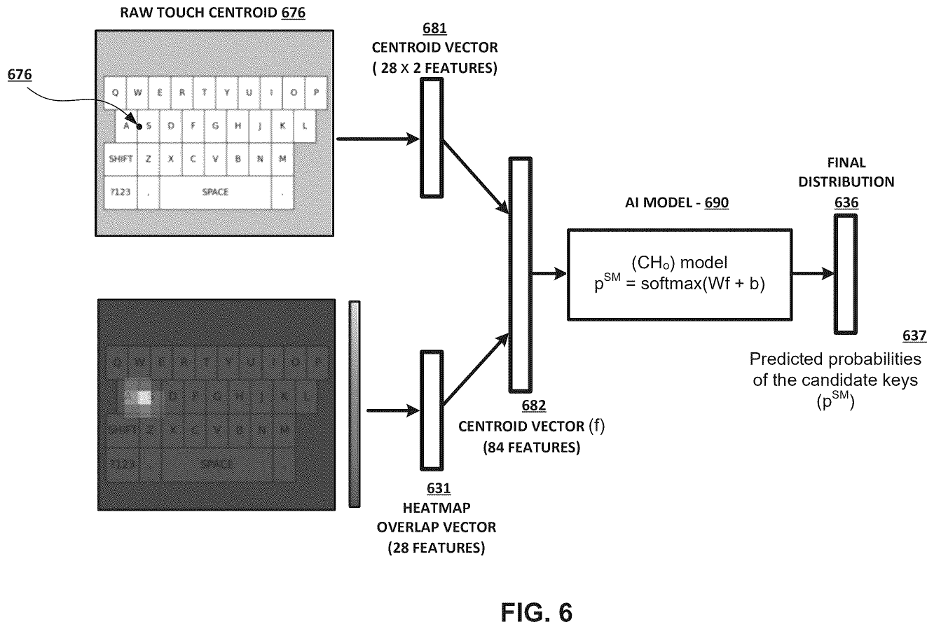

FIG. 6 depicts a (CHO) logistic regression type AI model 690 which takes as input, both raw touch centroid 676 and raw touch sensing image 626 and provides predicted probabilities of the candidate keys 637 (p^{SM}) using final distribution 136, in accordance with aspects of this disclosure. FIG. 6 is described with respect to computing device 102 of FIG. 1 and computing device 202 of FIG. 2. As depicted here, the terms W and b are trained parameters of AI model 690.

Multi-class logistic regression models were employed as spatial models for predicting the probabilities (p^{SM}) of the K candidate keys. This process is mathematically expressed according to Equation 3, set forth below, as follows:

$${p}^{SM} = softmax ( Wf + b ) ,$$

where p^{SM}∈[0,1]^{K}, f∈ [symbol] ^{d} is the feature vector of size d, and where W∈ [symbol] ^{K×d} and b∈ [symbol] ^{K} are model parameters for AI model 690. For AI model 690 variants using both raw touch centroid 676 and raw touch sensing image 626 as input, the two feature vectors are concatenated before being passed into the logistic regression type AI model 690. FIG. 6 demonstrates this process for AI model 690 that takes both raw touch centroid 676 and raw touch sensing image 626 as input using centroid vector 681 for raw touch centroid 676 and heatmap overlap vector 631 for raw touch sensing image 626, respectively.

Each of centroid vector 681 and heatmap overlap vector 631 may be combined (e.g., via a weighted combination) into feature vector (f) 682 via preprocessing before inputting feature vector (f) 682 into Ai model 690. The scikit-learn library version 1.0.2 was used to train variants of AI model 690. The training employed categorical cross-entropy loss (LCE) according to Equation 4, set forth below, as follows:

$${L}_{CE} = - \frac{1}{N} {\sum }_{i = 1}^{N} {\sum }_{k = 1}^{K} {y}_{i , k} log ( {p}_{i , k}^{SM} ) ,$$

and L2 regularization loss, according to Equation 5, set forth below, as follows:

$${L}_{2} = \frac{1}{2} {‖ W ‖}_{F}^{2} = \frac{1}{2} {\sum }_{k = 1}^{K} {\sum }_{j = 1}^{d} {W}_{k , j}^{2} ,$$

where, N represents the number of training examples, while

$${p}_{i , k}^{SM}$$

is the predicted probability of the candidate key k for the i^{th} example. The value y_{i,k} equals 1 if the label of the i^{th} example is key k, and 0 otherwise.

The final loss function is defined according to Equation 6, set forth below, as follows:

$$L = {L}_{CE} + \frac{1}{C} {L}_{2} ,$$

where C is a hyperparameter known as the inverse of regularization strength. The LBFGS solver was employed to optimize the models, and C was selected from the values {0.5, 1, 1.5, 2.0}, based on the best validation accuracy. Training continued until parameter convergence or after 1000 iterations. Further details regarding data splits and feature sets are discussed in greater detail below.

In addition to analyzing the spatial models, the interaction effects of three additional techniques were tested during decoding to further optimize the typing experience.

Combining spatial type AI models 690 with a language model generally improves key decoding accuracy. A finite-state transducer (FST) language model was utilized for the experiments, which has been successfully applied in various mobile text entry contexts. The FST model predicts the probability of the next character based on a prior context of up to five words. However, the FST language model accuracy in predicting the first character of each word may be low due to the inclusion of uncommon words in the constructed prompt set to balance the character unigram distribution. Additionally, the period “.” key was not represented within the training dataset.

Consequently, the following logic was applied when combining spatial model scores with language model scores: If the spatial model predicts PERIOD (“.”) or the PERIOD (“.”) key is the leading character of a word, then Answer

$$arg {max}_{k} \{ {p}_{k}^{SM} \} ,$$

otherwise, Answer

$$arg {max}_{k} \{ {p}_{k}^{SM} \times {p}_{k}^{LM} \} .$$

Here,

$${p}_{k}^{SM}$$

represents the spatial score, while

$${p}_{k}^{LM}$$

refers to the language model score for the candidate key k. The experiments used p^{SM} as the key probability predicted by the logistic regression model, while p^{LM} originated from the FST model.

When a user accurately taps a target key, the predicted key may still be incorrect if the language model signal outweighs the spatial signal, leading to unexpected results that could negatively affect the user experience. To address this, taps where the touch centroid is close to the center of a candidate key are treated as unambiguous, and the spatial model is bypassed, directly predicting the nearest candidate key instead.

A tap is considered unambiguous if the touch centroid (x,y) is near the center of a candidate key, k, whose center is at (xk,yk), such that |x−xₖ|<0.25wₖ and |y−yₖ|<0.25hₖ where wₖ and hₖ represent the width and height of key k, respectively. This approach shares similarities with the concept of anchoring.

To improve decoding accuracy and reduce surprises, the set of candidate keys was restricted to only those keys where raw touch centroid 676 is no farther from the key center than its neighboring keys. For example, if the touch point is near certain keys, the filtered candidate keys would be limited to {s, d, f, z, x, c, SPACE}, reducing the number of candidate answers from 28 to 7. This filtering technique helps avoid situations where the language model strongly contradicts the spatial signal from the touch point.

For evaluating the logistic regression type AI model 690 variants, two baseline methods were compared for key decoding: On-key and Distance. On-key predicts the key bounding box into which raw touch centroid 676 falls. If raw touch centroid 676 does not fall within any key bounding box, it predicts the closest key based on the Euclidean distance between raw touch centroid 676 and the key center. On-key only provides categorical predictions and does not calculate key probabilities. Distance predicts the candidate key with the minimum normalized distance between raw touch centroid 676 and the key center, regardless of where raw touch centroid 676 lands. The normalized distance to the kth key is computed according to Equation 7, set forth below, as follows:

$${d}_{k} = \sqrt{{( \frac{x - {x}_{k}}{W} )}^{2} + {( \frac{y - {y}_{k}}{H} )}^{2}} ,$$

where (x,y) is the touch centroid, where (xₖ, yₖ) represents the center of the kth key, where W is the keyboard width (1,440 pixels), and where H is the keyboard height (854 pixels).

For deriving key probabilities (i.e.,

$${p}_{k}^{SM} ) ,$$

each distance dₖ is input into a 1D Gaussian distribution to compute a probability density function (pdf) score sₖ according to Equation 8, set forth below, as follows:

$${s}_{k} = \frac{1}{\sqrt{2 π {σ}^{2}}} exp ( \frac{- {d}_{k}^{2}}{2 {σ}^{2}} ) .$$

The scores sₖ are normalized by the sum of all candidate scores to obtain the key probabilities according to Equation 9, set forth below, as follows:

$${p}_{k}^{SM} = \frac{{s}_{k}}{{\sum }_{j} {s}_{j}} .$$

The value of σ is obtained empirically, with σ=0.03 optimized for the categorical cross-entropy loss on validation splits.

Both baseline methods treat the SPACE key specially since its width (675 pixels) is significantly wider than other keys (135 pixels). For fair treatment, the distance along the x-axis to the SPACE key is considered zero if the x-coordinate of raw touch centroid 676 falls within the inner-left and inner-right boundaries of the SPACE key. Specifically, the distance starts being measured at the pixel positions

$$[ \frac{135}{2} , 675 - \frac{135}{2} ] - th$$

from the left edge of the SPACE key, rather than from the key center.

A first study aimed to collect raw touch sensing images 626 and raw touch centroids 676 while users typed known phrases. This data was used to train and compare machine-learning models that predict keys from input heatmaps or centroids.

A total of 24 participants familiar with mobile typing were recruited, with additional criteria of using English as their primary typing language and having no significant motor or visual impairments.

The task was divided into three blocks of 30 prompts (target sentences/phrases) each. Participants used two-thumb typing while holding a smartphone with both hands. In the first two blocks, participants were asked to type quickly while maintaining accuracy. In the third block, participants were instructed to type as fast as possible without concern for accuracy, creating more challenging tap input. Participants could edit typing errors, but this was not mandatory unless the edit distance from the prompt was too high (over 60%). Breaks were allowed between blocks.

Data was collected using mobile smart phone computing devices 102 (e.g., see FIG. 1) oriented in portrait mode. Computing devices 102 logged touch heatmaps at a capture rate of ˜237 frames per second.

A custom virtual keyboard 106 was used, with intelligent features like next-word prediction and haptic feedback disabled to avoid distractions. Auto-correction was enabled, but participants were discouraged from tapping suggestions.

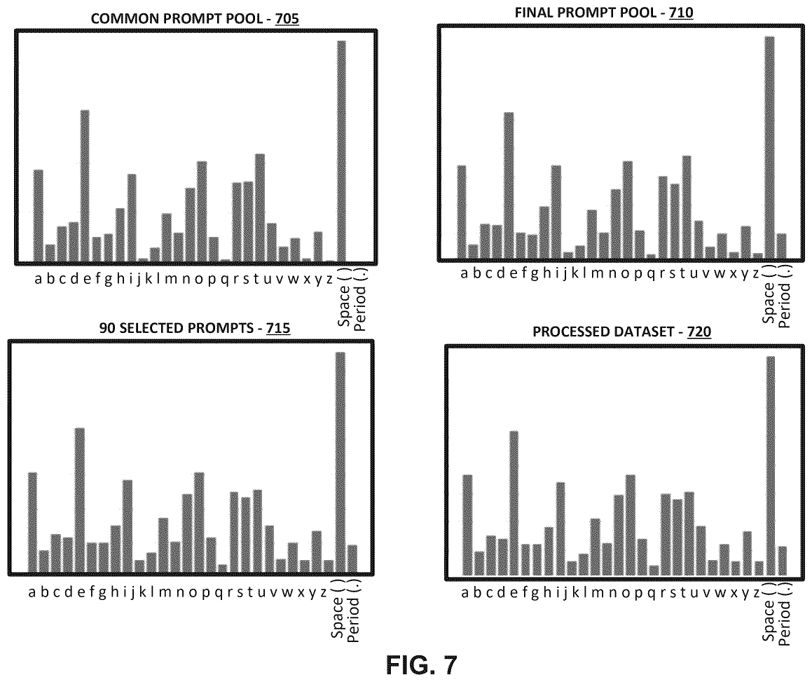

FIG. 7 depicts character distributions (from A to Z and SPACE, PERIOD on the x-axis) of a common prompt pool 705 (top left), a final prompt pool 710 for greedy selection (top right), 90 selected prompts 715 used for data collection (bottom left), and processed dataset 720 used for training and evaluation (bottom right), in accordance with aspects of this disclosure. FIG. 7 is described with respect to computing device 102 of FIG. 1 and computing device 202 of FIG. 2.

The prompt set used phrase sets from a common prompt pool 705 in text-entry research. To balance the distribution of rare characters (e.g., j, q, x, z), 30 new phrases containing rare characters were added. Phrases with punctuation or numbers were excluded to avoid the need for secondary layouts. Prompts were simple, with up to 6 words and limited rare words. Prompts with rare words had fewer total words to maintain simplicity. A word is considered rare if it is not in the list of the 50,000 most common English words according to the list of most common English words, in order of frequency.

A final set of 90 selected prompts 715 was selected for final prompt pool 710 using greedy selection, maximizing character-level entropy. Each participant typed 2,379 taps across the task to produce processed dataset 720 having a total of 57,369 examples, though the number of usable examples varied due to alignment issues.

The data collection included the touch centroid (x and y coordinates on the keyboard), the touch heatmap (of size 39×18), and the timestamp of each raw touch event, alongside the committed string. As a single tap may generate a sequence of touch heatmap events, depending on the duration of finger contact with the screen, the data from the first frame of the sequence was utilized for training and evaluation. The keyboard must visually respond to user taps by highlighting the pressed keys upon finger-down; thus, using the first frame data enables the keyboard to provide the earliest possible response to a given user tap.

After obtaining the touch points, alignment to the characters in the prompt was conducted to create input-output pairs for training and evaluation. This alignment can be divided into two cases, namely committed touch points and deleted touch points.

In this case, touch points in the committed string were aligned with the reference prompt. Since the committed string may contain errors, an algorithm which accommodates insertion, omission, substitution, and transposition errors, was utilized for alignment. For words in the committed string that resulted from auto-correction, alignment occurred first with the prompt to the corrected form, followed by alignment of the corrected form to the original form from which touch data was obtained. This chain of alignment enabled the generation of pairs of touch data and reference keys.

Deleted touch points provide useful signals in this context, as they represent instances where the keyboard used during data collection failed to produce the decoding results expected by the user, indicating areas for improvement. To infer the intended keys for the deleted touch points, the typing sequence (including backspaces) was replayed step by step. An alignment algorithm was applied before each deletion of a touch point. The reference text for alignment constituted a prefix of the prompt, extending one character longer than the current text to accommodate an omission error. Only those alignments not addressed during committed touch point alignment were retained.

Aligning deleted touch points may be imperfect, as the exact reason for a user deleting touch points cannot be known. This leads to ambiguous cases where multiple alignment hypotheses exist. For instance, given the prompt “Breathing is difficult,” if a user types “Be” and then deletes the letter e, it could be interpreted that the user intentionally typed e and forgot r, indicating a spelling error (omission), which does not align with the focus of the analysis. Alternatively, the user may have intended to type r but inadvertently missed it to the left, resulting in the keyboard interpreting the touch as “e,” a neighboring key of “r.” This scenario illustrates a spatial error of interest.

Another example involves the prompted word “missed,” where a user types “mis s d” and subsequently deletes the letter “d.” The deleted “d” could be aligned with either “e” or “d.” Due to the uncertainty regarding which alignment accurately reflects the user's intention, instances of this category, such as spelling (omission) errors versus spatial errors may be selectively excluded from a training dataset.

Lastly, alignment may yield keys that are too distant from the touch centroid on the QWERTY keyboard. For instance, with the prompt “Buffer zones near Iraq,” a user may type and submit “Buffer zones near Iran” due to a lack of attention to the prompt. In this case, the algorithm would align the user's tap of “n” to the reference character “q.” However, this scenario does not represent the spatial error of interest, as the touch centroid (near “n”) and the key “q” are positioned too far apart on the keyboard. Thus, such cases may also be excluded from a training dataset. Generally, examples where the touch centroid remained no farther than the immediate closest keys to the reference key, or an equivalent distance, are retained within the example training dataset.

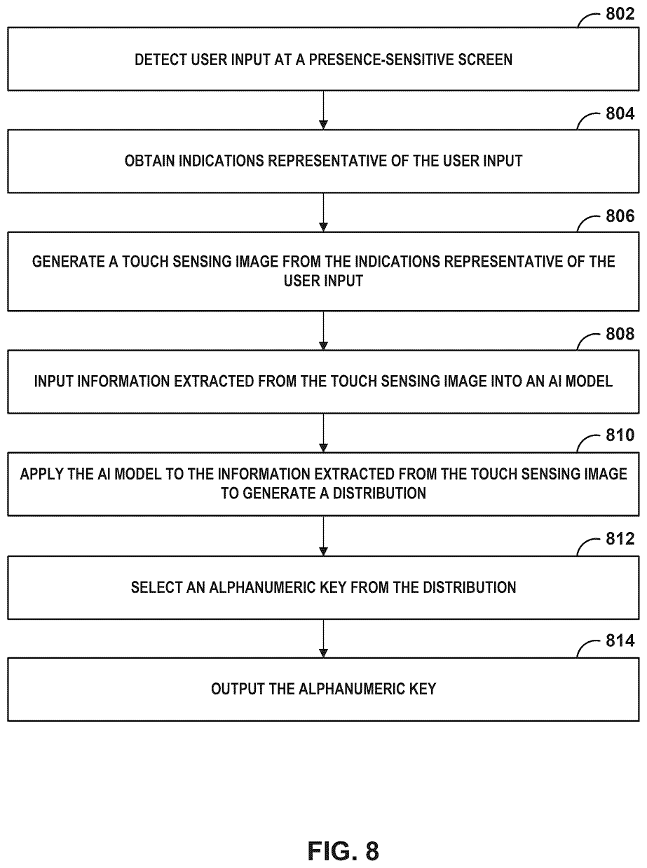

FIG. 8 is a flowchart illustrating example operations performed by an example computing device that is configured in accordance with one or more aspects of the present disclosure. FIG. 8 is described below in the context of keyboard decoding framework 100 of FIG. 1, computing device 202 of FIG. 2 and the conceptual diagram of FIG. 6.

As shown in FIG. 8, one or more processors 299 may detect user input at a presence-sensitive screen 212 (802). For example, one or more processors 299 of computing device 202 may detect user input at a presence-sensitive screen 212.

One or more processors 299 may obtain indications representative of the user input (804). For example, responsive to a detection of the user input at the presence-sensitive screen 212, one or more processors 299 of computing device 202 may obtain indications representative of the user input.

One or more processors 299 may generate a touch sensing image 221 from the indications representative of the user input (806). For example, one or more processors 299 of computing device 202 may generate a touch sensing image from the indications representative of the user input detected at the presence-sensitive screen 212.

Computing device 202 may input information extracted from the touch sensing image 221 into an artificial intelligence (AI) model 290. For example, one or more processors 299 of computing device 202 may input information extracted from the touch sensing image 221 into an artificial intelligence model 290

Computing device 202 may apply the artificial intelligence model to the information extracted from the touch sensing image to generate a distribution 136. For example, one or more processors 299 of computing device 202 may apply the artificial intelligence model 290 to the information extracted from the touch sensing image to generate a distribution 136 of candidate keys and candidate key scores for the candidate keys based on the touch sensing image 221.

Computing device 202 may select an alphanumeric key from the distribution 136. For example, one or more processors 299 of computing device 202 may select an alphanumeric key from the distribution 136 of candidate keys and candidate key scores.

Computing device 202 may output the alphanumeric key. For example, in response to a selection of the alphanumeric key, one or more processors 299 of computing device 202 may output the alphanumeric key selected to a user interface of the computing device.

This disclosure includes the following examples.

Example 1—A method comprising: detecting, by one or more processors of a computing device, user input at a presence-sensitive screen; responsive to a detection of the user input at the presence-sensitive screen, obtaining, by the one or more processors, indications representative of the user input; generating, by the one or more processors, a touch sensing image from the indications representative of the user input detected at the presence-sensitive screen; inputting, by the one or more processors, information extracted from the touch sensing image from the touch sensing image into an artificial intelligence model; applying the artificial intelligence model to the information extracted from the touch sensing image to generate a distribution of candidate keys and candidate key scores for the candidate keys based on the touch sensing image; selecting, by the one or more processors, an alphanumeric key from the distribution of candidate keys and candidate key scores; and responsive to a selection of the alphanumeric key, outputting, by the one or more processors, the alphanumeric key selected to a user interface of the computing device.

Example 2—The method of example 1, further comprising: transforming, by the one or more processors, the touch sensing image into a heatmap overlap vector; inputting, by the one or more processors, the heatmap overlap vector into the artificial intelligence model; and applying, by the one or more processors using the artificial intelligence model, logistic regression to the heatmap overlap vector to generate the distribution.

Example 3—The method of any combination of examples 1-2, further comprising: determining, by the one or more processors, a touch centroid corresponding to the user input entered at a region of the presence-sensitive screen; inputting, by the one or more processors, the information extracted from the touch sensing image as a first input into the artificial intelligence model in a form of a heatmap overlap vector; and inputting, by the one or more processors, the touch centroid as a second input into the artificial intelligence model in a form of a single point coordinate location within the region of the presence-sensitive screen.

Example 4—The method of example 3, wherein determining the touch centroid corresponding to the user input entered at the region of the presence-sensitive screen comprises one of: determining the touch centroid from the user input entered at the region of the presence-sensitive screen; or deriving the touch centroid from the touch sensing image.

Example 5—The method of any combination of examples 1-4, further comprising: extracting, by the one or more processors, touch centroid vector features from the user input or from the touch sensing image; combining, by the one or more processors, the touch centroid vector features with heatmap overlap vector features derived from the touch sensing image into a single combined feature vector; and inputting, by the one or more processors, the single combined feature vector into the artificial intelligence model.

Example 6—The method of example 5, further comprising: applying, by the one or more processors, a softmax function to the distribution generated by the artificial intelligence model to normalize the distribution having a sum of all candidate key scores equal to 1.

Example 7—The method of any combination of examples 1-6, further comprising: obtaining, by the one or more processors, multiple images as a series of discrete events corresponding to the indications representative of the user input entered at a region of the presence-sensitive screen generating, by the one or more processors, the touch sensing image from the multiple images; extracting, by the one or more processors, the information extracted from the touch sensing image to a heatmap overlap vector; and inputting, by the one or more processors, the heatmap overlap vector into the artificial intelligence model.

Example 8—The method of any combination of examples 1-7, further comprising: training, by the one or more processors, the artificial intelligence model using a training dataset; generalizing, by the one or more processors, the artificial intelligence model to unseen input data which forms no part of the training dataset; and generating, by the one or more processors using the artificial intelligence model, the distribution from the information extracted from the touch sensing image which form no part of the training dataset.

Example 9—The method of any combination of examples 1-8, further comprising: applying, by the one or more processors, a language model to the distribution of candidate keys and candidate key scores; generating, by the one or more processors using the language model, a single selected key from the distribution of candidate keys and candidate key scores, wherein the single selected key has a highest combined score from the AI model and the language model; and outputting, by the one or more processors, the single selected key as the alphanumeric key selected to the user interface of the computing device.

Example 10—The method of any combination of examples 1-9, further comprising: obtaining, by the one or more processors, with the indications representative of the user input, properties of the user input including at least one or more of interaction duration, interaction touch pressure, interaction touch size, interaction touch movement, interaction gesture direction, interaction handedness, interaction orientation, time between user interactions, prior selected keys from prior distributions of candidate keys and candidate key scores, and prior text corrections; applying, by the one or more processors, a language model to the distribution of candidate keys and candidate key scores; inputting, by the one or more processors, the properties into the language model in association with the distribution of candidate keys and candidate key scores; generating, by the one or more processors using the language model, a single selected key from the distribution of candidate keys and candidate key scores based at least in part on the properties; and outputting, by the one or more processors, the single selected key as the alphanumeric key selected to the user interface of the computing device.

Example 11—The method of any combination of examples 1-9, wherein the touch sensing image represents a two-dimensional spatial map of user touch interactions detected within a region of the presence-sensitive screen.

Example 12—The method of any combination of examples 1-11: wherein the user interface of the computing device is a virtual keyboard; and wherein the method further comprises: determining the user input entered is a key tap on the virtual keyboard based at least in part on the touch sensing image for the user input satisfying a threshold duration of time; selecting the alphanumeric key from the distribution of candidate keys and candidate key scores; and outputting, by the one or more processors, the alphanumeric key selected to the virtual keyboard.

Example 13—A computing device comprising: a presence-sensitive screen configured to detect user input; and one or more processors configured to: responsive to a detection of the user input at the presence-sensitive screen, obtain indications representative of the user input; generate a touch sensing image from the indications representative of the user input detected at the presence-sensitive screen; input information extracted from the touch sensing image from the touch sensing image into an artificial intelligence model; apply the artificial intelligence model to the information extracted from the touch sensing image to generate a distribution of candidate keys and candidate key scores for the candidate keys based on the touch sensing image; select an alphanumeric key from the distribution of candidate keys and candidate key scores; and responsive to a selection of the alphanumeric key, output the alphanumeric key selected to a user interface of the computing device.

Example 14—The computing device of example 13, wherein the one or more processors are further configured to: transform the touch sensing image into a heatmap overlap vector; input the heatmap overlap vector into the artificial intelligence model; and apply, using the artificial intelligence model, logistic regression to the heatmap overlap vector to generate the distribution.

Example 15—The computing device of any combination of examples 13-14, wherein the one or more processors are further configured to: determine a touch centroid corresponding to the user input entered at a region of the presence-sensitive screen; input the information extracted from the touch sensing image as a first input into the artificial intelligence model in a form of a heatmap overlap vector; and input the touch centroid as a second input into the artificial intelligence model in a form of a single point coordinate location within a region of the presence-sensitive screen.

Example 16—The computing device of any combination of examples 13-15, wherein to determine the touch centroid corresponding to the user input entered at the presence-sensitive screen, the one or more processors are further configured to: determine the touch centroid from the user input entered at a region of the presence-sensitive screen or derive the touch centroid from the touch sensing image.

Example 17—The computing device of any combination of examples 13-16, wherein the one or more processors are further configured to: extract touch centroid vector features from the user input or from the touch sensing image; combine the touch centroid vector features with heatmap overlap vector features derived from the touch sensing image into a single combined feature vector; and input the single combined feature vector into the artificial intelligence model.

Example 18—The computing device of any combination of examples 13-17, wherein the one or more processors are further configured to: apply a softmax function to the distribution generated by the artificial intelligence model to normalize the distribution having a sum of all candidate key scores equal to 1.

Example 19—The computing device of any combination of examples 13-18, wherein the one or more processors are further configured to: apply a language model to the distribution of candidate keys and candidate key scores; and generate, using the language model, a single selected key from the distribution of candidate keys and candidate key scores, wherein the single selected key has a highest combined score from the AI model and the language model.

Example 20—Non-transitory computer-readable storage media comprising instructions that, when executed, configure one or more processors of a computing device to: detect user input at a presence-sensitive screen; responsive to a detection of the user input at the presence-sensitive screen, obtain indications representative of the user input; generate a touch sensing image from the indications representative of the user input detected at the presence-sensitive screen; input information extracted from the touch sensing image into an artificial intelligence model; apply the artificial intelligence model to the information extracted from the touch sensing image to generate a distribution of candidate keys and candidate key scores for the candidate keys based on the touch sensing image; select an alphanumeric key from the distribution of candidate keys and candidate key scores; and responsive to a selection of the alphanumeric key, output the alphanumeric key selected to a user interface of the computing device.

Example 21—A computer program product comprising one or more instructions that, when executed by at least one processor, cause the at least one processor to perform any of the methods of examples 1-12.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of a computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structures suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of inter-operative hardware units, including one or more processors as described above, in conjunction with suitable software and/or firmware.

Various embodiments have been described. These and other embodiments are within the scope of the following claims.

What is claimed is:

1. A method comprising:
detecting, by one or more processors of a computing device, user input at a presence-sensitive screen;
responsive to a detection of the user input at the presence-sensitive screen, obtaining, by the one or more processors, indications representative of the user input;
generating, by the one or more processors, a touch sensing image from the indications representative of the user input detected at the presence-sensitive screen;
inputting, by the one or more processors, information extracted from the touch sensing image into an artificial intelligence model;
applying, by the one or more processors, the artificial intelligence model to the information extracted from the touch sensing image to generate a distribution of candidate keys and candidate key scores for the candidate keys based on the touch sensing image;
selecting, by the one or more processors, an alphanumeric key from the distribution of candidate keys and candidate key scores; and
responsive to a selection of the alphanumeric key, outputting, by the one or more processors, the alphanumeric key selected to a user interface of the computing device.

2. The method of claim 1, further comprising:
transforming, by the one or more processors, the touch sensing image into a heatmap overlap vector;
inputting, by the one or more processors, the heatmap overlap vector into the artificial intelligence model; and
applying, by the one or more processors using the artificial intelligence model, logistic regression to the heatmap overlap vector to generate the distribution.

3. The method of claim 1, further comprising:
determining, by the one or more processors, a touch centroid corresponding to the user input entered at a region of the presence-sensitive screen;
inputting, by the one or more processors, the information extracted from the touch sensing image as a first input into the artificial intelligence model in a form of a heatmap overlap vector; and
inputting, by the one or more processors, the touch centroid as a second input into the artificial intelligence model in a form of a single point coordinate location within a region of the presence-sensitive screen.

4. The method of claim 3, wherein determining the touch centroid corresponding to the user input entered at the region of the presence-sensitive screen comprises one of:
determining the touch centroid from the user input entered at the region of the presence-sensitive screen; or
deriving the touch centroid from the touch sensing image.

5. The method of claim 1, further comprising:
extracting, by the one or more processors, touch centroid vector features from the user input or from the touch sensing image;
combining, by the one or more processors, the touch centroid vector features with heatmap overlap vector features derived from the touch sensing image into a single combined feature vector; and
inputting, by the one or more processors, the single combined feature vector into the artificial intelligence model.

6. The method of claim 5, further comprising:
applying, by the one or more processors, a softmax function to the distribution generated by the artificial intelligence model to normalize the distribution having a sum of all candidate key scores equal to 1.

7. The method of claim 1, further comprising:
obtaining, by the one or more processors, multiple images as a series of discrete events corresponding to the indications representative of the user input entered at a region of the presence-sensitive screen
generating, by the one or more processors, the touch sensing image from the multiple images;
extracting, by the one or more processors, the information from the touch sensing image to a heatmap overlap vector; and
inputting, by the one or more processors, the heatmap overlap vector into the artificial intelligence model.

8. The method of claim 1, further comprising:
training, by the one or more processors, the artificial intelligence model using a training dataset;
generalizing, by the one or more processors, the artificial intelligence model to unseen input data which forms no part of the training dataset; and
generating, by the one or more processors using the artificial intelligence model, the distribution from the information extracted from the touch sensing image which form no part of the training dataset.

9. The method of claim 1, further comprising:
applying, by the one or more processors, a language model to the distribution of candidate keys and candidate key scores;
generating, by the one or more processors using the language model, a single selected key from the distribution of candidate keys and candidate key scores, wherein the single selected key has a highest combined score from the AI model and the language model; and
outputting, by the one or more processors, the single selected key as the alphanumeric key selected to the user interface of the computing device.

10. The method of claim 1, further comprising:
obtaining, by the one or more processors, with the indications representative of the user input, properties of the user input including at least one or more of interaction duration, interaction touch pressure, interaction touch size, interaction touch movement, interaction gesture direction, interaction handedness, interaction orientation, time between user interactions, prior selected keys from prior distributions of candidate keys and candidate key scores, and prior text corrections;
applying, by the one or more processors, a language model to the distribution of candidate keys and candidate key scores;
inputting, by the one or more processors, the properties into the language model in association with the distribution of candidate keys and candidate key scores;
generating, by the one or more processors using the language model, a single selected key from the distribution of candidate keys and candidate key scores based at least in part on the properties; and
outputting, by the one or more processors, the single selected key as the alphanumeric key selected to the user interface of the computing device.

11. The method of claim 1, wherein the touch sensing image represents a two-dimensional spatial map of user touch interactions detected within a region of the presence-sensitive screen.

12. The method of claim 1:
wherein the user interface of the computing device is a virtual keyboard; and
wherein the method further comprises:
determining the user input entered is a key tap on the virtual keyboard based at least in part on the touch sensing image for the user input satisfying a threshold duration of time;
selecting the alphanumeric key from the distribution of candidate keys and candidate key scores; and
outputting, by the one or more processors, the alphanumeric key selected to the virtual keyboard.

13. A computing device comprising:
a presence-sensitive screen configured to detect user input; and
one or more processors configured to:
responsive to a detection of the user input at the presence-sensitive screen, obtain indications representative of the user input;
generate a touch sensing image from the indications representative of the user input detected at the presence-sensitive screen;
input information extracted from the touch sensing image into an artificial intelligence model;
apply the artificial intelligence model to the information extracted from the touch sensing image to generate a distribution of candidate keys and candidate key scores for the candidate keys based on the touch sensing image;
select an alphanumeric key from the distribution of candidate keys and candidate key scores; and
responsive to a selection of the alphanumeric key, output the alphanumeric key selected to a user interface of the computing device.

14. The computing device of claim 13, wherein the one or more processors are further configured to:
transform the touch sensing image into a heatmap overlap vector;
input the heatmap overlap vector into the artificial intelligence model; and
apply, using the artificial intelligence model, logistic regression to the heatmap overlap vector to generate the distribution.

15. The computing device of claim 13, wherein the one or more processors are further configured to:
determine a touch centroid corresponding to the user input entered at a region of the presence-sensitive screen;
input the information extracted from the touch sensing image as a first input into the artificial intelligence model in a form of a heatmap overlap vector; and
input the touch centroid as a second input into the artificial intelligence model in a form of a single point coordinate location within the region of the presence-sensitive screen.

16. The computing device of claim 13, wherein to determine the touch centroid corresponding to the user input entered at the presence-sensitive screen, the one or more processors are further configured to:
determine the touch centroid from the user input entered at a region of the presence-sensitive screen or derive the touch centroid from the touch sensing image.

17. The computing device of claim 13, wherein the one or more processors are further configured to:
extract touch centroid vector features from the user input or from the touch sensing image;
combine the touch centroid vector features with heatmap overlap vector features derived from the touch sensing image into a single combined feature vector; and
input the single combined feature vector into the artificial intelligence model.

18. The computing device of claim 13, wherein the one or more processors are further configured to:
apply a softmax function to the distribution generated by the artificial intelligence model to normalize the distribution having a sum of all candidate key scores equal to 1.

19. The computing device of claim 13, wherein the one or more processors are further configured to:
apply a language model to the distribution of candidate keys and candidate key scores; and
generate, using the language model, a single selected key from the distribution of candidate keys and candidate key scores, wherein the single selected key has a highest combined score from the AI model and the language model.

20. Non-transitory computer-readable storage media comprising instructions that, when executed, configure one or more processors of a computing device to:
detect user input at a presence-sensitive screen;
responsive to a detection of the user input at the presence-sensitive screen, obtain indications representative of the user input;
generate a touch sensing image from the indications representative of the user input detected at the presence-sensitive screen;
input information extracted from the touch sensing image into an artificial intelligence model;
apply the artificial intelligence model to the information extracted from the touch sensing image to generate a distribution of candidate keys and candidate key scores for the candidate keys based on the touch sensing image;
select an alphanumeric key from the distribution of candidate keys and candidate key scores; and
responsive to a selection of the alphanumeric key, output the alphanumeric key selected to a user interface of the computing device.
